(19) United States
(12) Patent Application Publication
(10) Pub. No.: US 2018/0198983 A1
(43) Pub. Date: Jul. 12, 2018

(54) IMAGE PICKUP APPARATUS, IMAGE PICKUP SYSTEM, IMAGE PICKUP METHOD, IMAGE PICKUP PROGRAM, AND DISPLAY APPARATUS FOR IMAGE PICKUP

(71) Applicant: Olympus Corporation, Tokyo (JP)

(72) Inventors: Yoshiyuki Fukuya, Sagamihara-shi (JP); Yoshihisa Ogata, Tokyo (JP); Haruhito Fuji, Tokyo (JP)

(21) Appl. No.: 15/859,290

(22) Filed: Dec. 29, 2017

(30) Foreign Application Priority Data
Jan. 6, 2017 (JP) 2017-001413
Jul. 19, 2017 (JP) 2017-140322

(51) Int. Cl. H04N 5/232; G03B 13/24

(52) U.S. Cl. CPC H04N 5/23293; H04N 5/23216; G03B 13/24; H04N 5/23229

(57) ABSTRACT

An image pickup apparatus of the present invention includes an image pickup section configured to receive an optical image of an object and generate and output image data, a display section configured to display an image based on the image data outputted from the image pickup section and various kinds of information, a communication section configured to perform communication between the communication section and a terminal apparatus and acquire incidental information concerning the object, and a display control section configured to perform processing of superposing/displaying an image in the image displayed on the display section based on the incidental information corresponding to the image. The display control section performs display control for displaying the image based on the incidental information in a position designated in advance in a display screen of the display section.

This application claims the benefit of Japanese Applications No. 2017-001413 filed in Japan on Jan. 6, 2017, No. 2017-140322 filed in Japan on Jul. 19, 2017, the contents of which are incorporated herein by their reference.

### BACKGROUND OF THE INVENTION

### 1. Field of the Invention

The present invention relates to an image pickup apparatus, an image pickup system, an image pickup method, an image pickup program, and a display apparatus for image pickup that can record, when acquiring an image of an object, incidental information related to the object as tag data.

### 2. Description of Related Art

There has been generally put to practical use and widely spread an image pickup apparatus or the like including an image display apparatus or the like that sequentially photoelectrically converts, using a photoelectric conversion device or the like (hereinafter referred to as image pickup device), optical images formed by an image pickup optical system, records an image signal obtained by the photoelectric conversion in a storage medium as digital image data of a predetermined form, and displays a still image or a movie on the basis of the digital image data.

The image pickup apparatus or the like of this type is sometimes used in a use for sequentially recording, with time, as images (photographs), various scenes, changes of a specific object, or the like in an event, construction work, or the like set as a recording target (hereinafter abbreviated as “recording target construction work or the like”) in order to record a series of acts, a progress situation, a process, or the like in, for example, various events, work, or the like.

In this case, the recording target construction work or the like is, more specifically, for example, a process record of manufacturing and production work of various manufactured products, or work pieces, or the like besides, for example, various event records of a ceremonial occasion such as a coming-of-age ceremony, a marriage ceremony, or a funeral, or the like and a construction work progress situation record of engineering work, building work, or the like.

In the past, for example, when the construction work situation progress record of engineering work, building work, or the like is performed, images are acquired at each of stages of the recording target construction work or the like. In that case, information related to the images, that is, incidental information such as situation explanation information of the recording target construction work or the like is recorded in association with the images.

As the situation explanation information of the recording target construction work or the like, there is, for example, basic information such as a date and a place and specific information concerning the recording target construction work or the like (a construction work name, a work name, an object name, a company name, other memoranda, etc.).

In the past, when an image of a desired object is picked up, an image of a substantial blackboard on which these kinds of information are described or a blackboard image generated on the basis of electronic data is picked up to be photographed in the same screen as the object.

A large amount of image data acquired in this way are arranged as appropriate and used in the case of, for example, an interim progress report during the progress of the recording target construction work or the like or a result report at an end time or a completion time of the recording target construction work or the like.

In recent years, when the large amount of image data acquired by the image pickup apparatuses are treated, for example, a small personal information terminal apparatus (a so-called personal computer; hereinafter abbreviated as “PC”) is widely used.

Therefore, concerning an image pickup method performed using an image pickup system including an image pickup apparatus and a PC devised to automate a part of various processes in a series of work for picking up (recording) a large amount of image data (e.g., image data of a construction work site), classifying the image data, and arranging the image data to simplify the arrangement of the large amount of image data and an image pickup program applied to the image pickup system, various proposals have been made by, for example, Japanese Patent Application Laid-Open Publication No. 2014-157596.

Means disclosed by Japanese Patent Application Laid-Open Publication No. 2014-157596 described above or the like is a computer program for automatically arranging a large amount of image data in which processes of construction work are recorded. The computer program disclosed by the publication stores various kinds of information (referred to as blackboard information) as electronic information data (referred to as blackboard information data) in advance, generates a predetermined blackboard image on the basis of the blackboard information data, superimposes and displays the blackboard image on a live-view image, and, when acquiring image data when a shutter button is pressed, prepares blackboard combined image data on which a blackboard image corresponding to the image data is superimposed, and records blackboard information data corresponding to the acquired image data in association with the image data. Further, the computer program classifies and saves a plurality of blackboard combined image data generated as explained above in corresponding folders on the basis of the blackboard information data.

### SUMMARY OF THE INVENTION

An image pickup apparatus according to an aspect of the present invention includes: an image pickup section configured to receive an optical image of an object and generate and output image data; a display section configured to display an image based on the image data outputted from the image pickup section and various kinds of information; a communication section configured to perform communication between the communication section and a terminal apparatus and acquire incidental information concerning the object; and a display control section configured to perform processing of superimposing/displaying an image in the image displayed on the display section based on the incidental information corresponding to the image. The display control section performs display control for causing the display section to display the image based on the incidental information in a position designated in advance in a display screen of the display section.

An image pickup system according to an aspect of the present invention includes: an image pickup apparatus including: an image pickup section configured to receive an optical image of an object and generate and output image data; a display section configured to display an image based on the image data outputted from the image pickup section and various kinds of information; a body-side communication section configured to perform communication between the body-side communication section and a terminal apparatus and acquire incidental information concerning the object; and a display control section configured to perform processing of superimposing/displaying an image in the image displayed on the display section based on the incidental information corresponding to the image in a position designated in advance; and a terminal apparatus including: a terminal-side communication section configured to perform communication between the terminal-side communication section and the image pickup apparatus via the body-side communication section; a recording section configured to record an information data group concerning a recording target event including a plurality of kinds of incidental information concerning a plurality of image pickup object; and an image processing section configured to prepare an incidental information image based on incidental information concerning each of individual image pickup objects on the basis of information data group recorded in the recording section.

An image pickup method according to an aspect of the present invention includes: preparing a plurality of incidental information images corresponding to each of individual image pickup objects on the basis of an information data group concerning a recording target event including a plurality of kinds of incidental information concerning a plurality of image pickup objects; transferring the plurality of incidental information images between a terminal apparatus and an image pickup apparatus; receiving an optical image of the image pickup object and generating image data; displaying an image based on the image data and superimposing and displaying, in a position designated in advance in a display screen, a specific incidental information image corresponding to the displayed image among the plurality of incidental information images; and recording image data representing the displayed image and data representing the incidental information image corresponding to the image data in association with each other.

An image pickup program according to an aspect of the present invention includes: preparing a plurality of incidental information images corresponding to each of individual image pickup objects on the basis of an information data group concerning a recording target event including a plurality of kinds of incidental information concerning a plurality of image pickup objects; receiving an optical image of the image pickup object and generating image data; displaying an image based on the image data and superimposing and displaying, in a position designated in advance in a display screen, a specific incidental information image corresponding to the displayed image among the plurality of incidental information images; and recording image data representing the displayed image and data representing the incidental information image corresponding to the image data in association with each other.

A display apparatus for image pickup according to an aspect of the present invention includes: a display section configured to display an image based on image data outputted from an image pickup section, which is configured to receive an optical image of an object and generate and output image data, and various kinds of information; a communication section configured to perform communication between the communication section and a terminal apparatus and acquire incidental information concerning the object; and a display control section configured to perform processing of superimposing/displaying an image in the image displayed on the display section based on the incidental information corresponding to the image. The display control section performs display control for displaying the image based on the incidental information in a position designated in advance in a display screen of the display section.

Advantages of the present invention will be further clarified from the following detailed explanation.

### BRIEF DESCRIPTION OF THE DRAWINGS

FIG. 1 is a system block configuration diagram schematically showing configurations of an image pickup apparatus and an image pickup system applied with the image pickup apparatus of an embodiment of the present invention;

FIG. 2 is a conceptual diagram schematically showing a configuration of the entire image pickup system shown in FIG. 1;

FIG. 3 is a conceptual diagram showing a state at a time when recording operation of recording target construction work or the like is performed using the image pickup system shown in FIG. 1;

FIG. 4 is a diagram showing an example of a display form of blackboard specification data prepared in a terminal apparatus in the image pickup system shown in FIG. 1;

FIG. 5 is a diagram showing an example of a display form of a simple blackboard image based on blackboard specification data superimposed and displayed on a live-view image in the image pickup apparatus in the image pickup system shown in FIG. 1;

FIG. 6 is a diagram showing an example of a display form of the blackboard specification data superimposed and displayed on the live-view image in the image pickup apparatus in the image pickup system shown in FIG. 1 and an example of a warning display appearing when setting of a blackboard image size by the blackboard specification data is too small;

FIG. 7 is a diagram showing an example of a display form of a combined image attached with a blackboard image displayed in the terminal apparatus on the basis of blackboard specification data corresponding to image data acquired in the image pickup apparatus in the image pickup system shown in FIG. 1;

FIG. 8 is a diagram showing an example of a recording report prepared using the image pickup system shown in FIG. 1;

FIG. 9 is a conceptual diagram in the case in which a dimension value of an object is calculated from acquired image data in the image pickup apparatus shown in FIG. 1;

FIG. 10 is a flowchart of a material preparation sequence performed in the image pickup system shown in FIG. 1;

FIG. 11 is a flowchart showing action of the image pickup apparatus in the image pickup system shown in FIG. 1;

FIG. 12 is a flowchart showing action of the terminal apparatus in the image pickup system shown in FIG. 1;

FIG. 13 is a flowchart branching from step S52 of FIG. 12; and

FIG. 14 is a flowchart branching from step S58 of FIG. 12.

### DETAILED DESCRIPTION OF THE PREFERRED EMBODIMENTS

The present invention is explained below with reference to an embodiment shown in the figures. Respective drawings used for the following explanation are schematically shown. In order to show respective components in recognizable sizes on the drawings, dimensional relations, scales, and the like of respective members are sometimes differentiated and shown for each of the respective components. Therefore, the present invention is not limited to only illustrated forms concerning numbers of the respective components described in the respective drawings, shapes of the respective components, ratios of sizes of the respective components, relative positional relations of the respective components, and the like.

An image pickup apparatus of an embodiment of the present invention is an image pickup apparatus including an image display apparatus, for example, a liquid crystal display (LCD) or an organic electro-luminescence (OEL) display configured to sequentially photoelectrically convert, for example, optical images formed by an image pickup optical system using, for example, a photoelectric conversion device (hereinafter referred to as image pickup device) such as a CCD (charge coupled device) image sensor or a CMOS (complementary metal oxide semiconductor) image sensor, record an image signal obtained by the photoelectric conversion in a storage medium as image data of a predetermined form (e.g., digital image data representing a still image or a movie), and reproduce and display the still image or the movie on the basis of the digital image data recorded in the storage medium. More specifically, for example, a digital camera is illustrated as the image pickup apparatus.

As an image pickup system of the embodiment of the present invention, a system is illustrated which is configured by the image pickup apparatus, a small personal information terminal apparatus used to cooperate with the image pickup apparatus, the terminal apparatus being capable of performing wireless communication between the terminal apparatus and another electronic apparatus and transmitting and receiving various data, for example, a personal computer (a desktop PC, a notebook PC, or a tablet PC) or a smartphone.

The image pickup system is capable of transmitting and receiving various data between the image pickup apparatus and the terminal apparatus using a network connected by wireless communication or wired communication, for example, the Internet or a local area network.

As the image pickup apparatus and the image pickup system of the embodiment of the present invention, more specifically, for example, an image pickup apparatus for construction work photograph and an image pickup system for construction work photograph suitable for performing recording of various scenes in a construction work site of engineering work, building work, or the like, a change with time or the like in a work stage of a specific object, and a progress situation or the like of recording target construction work.

### Embodiment

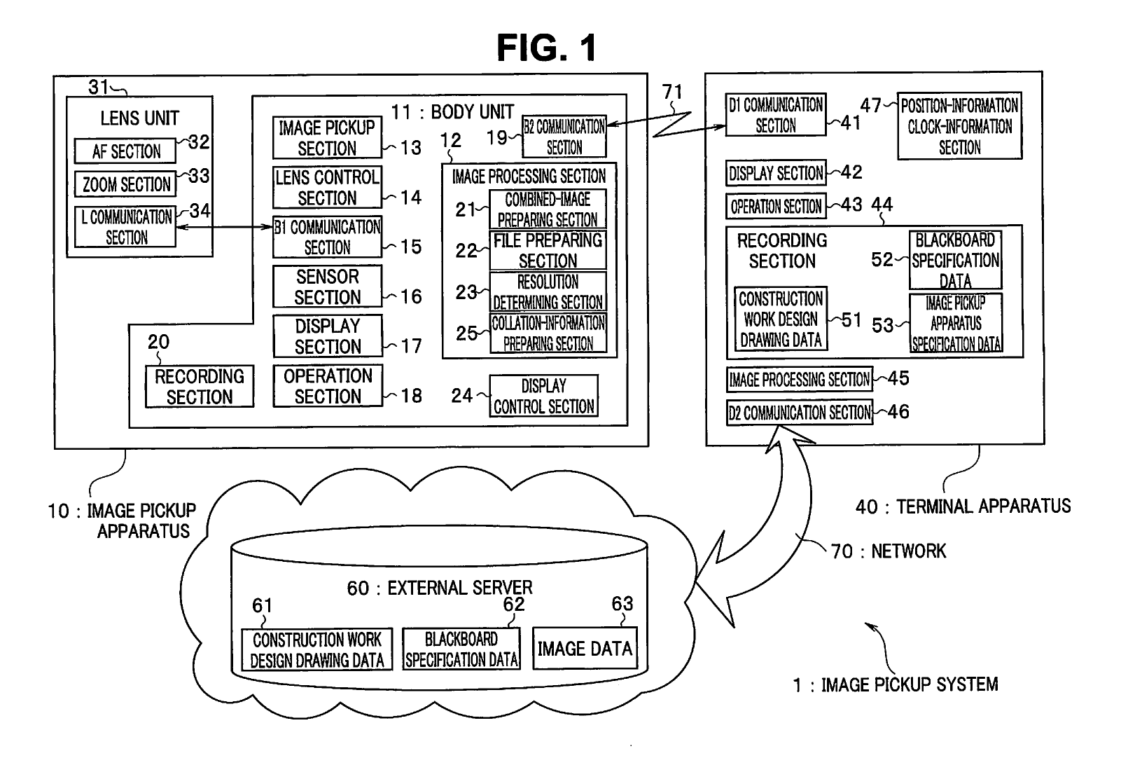

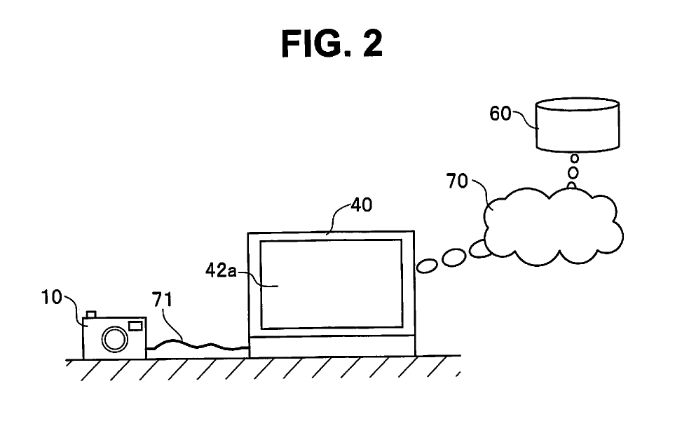

First, configurations of an image pickup apparatus and an image pickup system applied with the image pickup apparatus of an embodiment of the present invention are explained below with reference to FIGS. 1 and 2. FIG. 1 is a system block configuration diagram schematically showing the image pickup apparatus and the image pickup system applied with the image pickup apparatus of the embodiment of the present invention. FIG. 2 is a conceptual diagram schematically showing a configuration of the entire image pickup system of the present embodiment.

An image pickup system 1 applied with an image pickup apparatus 10 of the embodiment of the present invention is configured by, as shown in FIG. 1, the image pickup apparatus 10, a terminal apparatus 40, and an external server 60.

The image pickup apparatus 10 and the terminal apparatus 40 are capable of transmitting and receiving data between the image pickup apparatus 10 and the terminal apparatus 40 using existing communication means 71 (explained in detail below) such as near field wireless communication or wired communication (explained in detail below). The terminal apparatus 40 and the external server 60 are capable of transmitting and receiving data to and from each other through wireless communication or wired communication via an existing network 70. Illustration of the network 70 in FIGS. 1 and 2 are shown assuming a wireless network such as the Internet capable of performing wireless communication.

The image pickup apparatus 10 is configured by a body unit 11 and a lens unit 31. The body unit 11 and the lens unit 31 are separately or integrally configured. That is, as the image pickup apparatus 10 of the present embodiment, it is possible to apply both of an image pickup apparatus of a lens replacement type in which the lens unit 31 is detachably attachable to the body unit 11 and an image pickup apparatus of a lens fixed type in which the body unit 11 and the lens unit 31 are integrally configured.

The image pickup apparatus 10 of the present embodiment includes various kinds of performance such as sufficient waterproof, dustproof, shock resistance, load resistance, and low-temperature resistance such that the image pickup apparatus 10 can be used under severe environments such as construction work sites of engineering work and building work. Note that a specific component for realizing the various kinds of performance is a portion not directly related to the present invention. Therefore, it is assumed that the same components as the components applied in an electronic apparatus such as an image pickup apparatus spread to the public in the past are adopted. Detailed explanation concerning the components is omitted.

The body unit 11 includes an image processing section 12, an image pickup section 13, a lens control section 14, a body-side first communication section 15 (in FIG. 1, abbreviated as “B1 communication section”, a sensor section 16, an image-pickup-apparatus-side display section 17 (in FIG. 1, “image-pickup-apparatus-side” is omitted; hereinafter referred to accordingly), an image-pickup-apparatus-side operation section 18 (in FIG. 1, “image-pickup-apparatus-side” is omitted; hereinafter referred to accordingly), a body-side second communication section 19 (in FIG. 1, abbreviated as “B2 communication section”), an image-pickup-apparatus-side recording section 20 (in FIG. 1, “image-pickup-apparatus-side” is omitted; hereinafter referred to accordingly), and a display control section 24.

The image processing section 12 is a processing circuit configured to receive image data outputted from the image pickup section 13, blackboard information data transferred from the terminal apparatus 40, and the like and perform various kinds of signal processing. The image processing section 12 includes a combined-image preparing section 21, a file preparing section 22, and a resolution determining section 23.

The combined-image preparing section 21 is a processing circuit configured to perform, for example, processing for associating image data outputted from the image pickup section 13 and blackboard information data, which is incidental information of an object included in the image data. Since the image data and the blackboard information data are associated by the combined-image preparing section 21, when the respective data are transferred to the terminal apparatus 40, (in the image processing section 45) on the terminal apparatus 40 side, predetermined image combination processing or the like is performed and combined image data attached with a blackboard image (an incidental information image) is prepared. Note that the blackboard information data is data for determining specifications of the blackboard image. Therefore, the blackboard information data is hereinafter referred to as blackboard specification data.

The file preparing section 22 is a circuit section for filing image data and blackboard specification data corresponding to and associated with the image data as one image file.

The resolution determining section 23 is a circuit section configured to determine on the basis of information concerning a recording image size set in the image pickup apparatus 10 and set size information of a blackboard image whether the blackboard image size is appropriate. That is, the determination performed in the resolution determining section 23 is, more specifically, for example, when a blackboard image corresponding to predetermined image data is subjected to combination processing, for example, determination of resolution (optical resolution) of the blackboard image combined in the image data, that is, identification ability of blackboard information (character information) described in the blackboard image (whether the blackboard information can be surely read).

A collation-information preparing section 25 prepares collation information for preventing falsification of combined image data. As the collation information, the collation-information preparing section 25 prepares, for example, a hash value based on the combined image data. The hash value (hash code) is a value calculated by performing predetermined arithmetic processing called hash function on the data on which the hash value is based. As representative hash functions, SHA-1, SHA-2, MD5, and the like are known. The hash value is sometimes called message digest and fingerprint as well.

The image pickup section 13 is configured by, for example, a photoelectric conversion device (hereinafter referred to as image pickup device) or the like configured to receive an optical image of an object formed via the lens unit 31 and photoelectrically convert the optical image to generate an image signal, and various electronic circuits such as a driving circuit configured to drive the image pickup device and analog-digital conversion circuit configured to receive an image signal (an analog signal) outputted from the image pickup device and generate image data (a digital signal) of a predetermined form. As the image pickup section 13 itself, an image pickup section having the same configuration as an image pickup apparatus spread to the public in the past is applied.

The lens control section 14 is a control circuit configured to control the lens unit 31. The lens control section 14 controls an AF section 32, a zoom section 33, and the like explained below of the lens unit 31 via the body-side first communication section 15 and a lens-side communication section 34 and performs not-shown aperture control or shutter control (in the case of a lens shutter) besides an automatic focus adjustment operation, a zoom operation, and the like of the lens unit 31.

The body-side first communication section (the B1 communication section) 15 is a first communication section provided on the body unit 11 side. The body-side first communication section 15 is a circuit section for transmitting and receiving a control signal, data, and the like between the body unit 11 and (the lens-side communication section 34 of) the lens unit 31.

The sensor section 16 is a circuit section including various sensors necessary as appropriate such as a gyro sensor for detecting micro vibration applied to the image pickup apparatus 10 and performing image stabilization control and an eye sensor for performing switching of a back monitor and an electronic view finder in the display section 17 explained below and detection circuits corresponding to the sensors besides an acceleration sensor, other detection circuits, and the like configured to detect states (lateral and longitudinal postures, etc.) of the image pickup apparatus 10.

The display section 17 is a display unit for receiving an output signal from the image pickup section 13 and sequentially continuously displaying picked-up images (live-view images), displaying an image based on image data recorded in a storage medium of the recording section 20, and appropriately switching and displaying a menu image and the like for performing setting in the image pickup apparatus 10. As the display section 17, there are a back monitor provided in a back of the image pickup apparatus 10, an electronic view finder (EVF), and the like.

The operation section 18 includes a plurality of operation members configured to perform various kinds of operation on the image pickup apparatus side, a plurality of switch members functioning as electronic components configured to receive action of the plurality of operation members, and an electronic circuit section including the plurality of switch members. As the operation section 18, there are a touch panel and the like provided on a display surface of the display section 17 besides mechanism switch components and the like of various forms such as a push button type, a slide type, and a rotary type.

The body-side second communication section (the B2 communication section) 19 is a second communication section provided on the body unit 11 side. The body-side second communication section 19 is a circuit section for transmitting and receiving various data such as image data and blackboard specification data between the body unit 11 and (the terminal-side first communication section 41 explained in detail below of) the terminal apparatus 40.

The recording section 20 is a constituent unit configured by a storage medium (not shown in the figure) configured to store image data for recording acquired by the image pickup section 13 and applied with predetermined signal processing in the image processing section 12, a driving circuit configured to drive the storage medium, and the like.

The display control section 24 is a circuit section configured to perform driving control of the display section 17. The display control section 24 receives, for example, an operation signal outputted from the operation section 18 and performs switching control of display content displayed on the display section 17 and performs, for example, switching control of the back monitor and the electronic view finder. The display control section 24 also performs, for example, control of a live-view image. For example, when receiving an output from the image pickup section 13 and displaying a live-view image on the display section 17, the display control section 24 performs display control for, for example, superimposing and displaying a predetermined blackboard image on a display screen of the live-view image. In this case, the display control section 24 also performs display control for a position and a size for displaying the blackboard image on the basis of data designated in advance.

Further, the display control section 24 receives an operation input from the operation section 18 and also performs display control for changing a display position and a display size in a display screen of the blackboard image. More specifically, for example, in a state in which the blackboard image is superimposed and displayed in the live-view image, when a user taps any position on the touch panel included in the operation section 18, the display control is performed to move a position of the blackboard image from a position where the blackboard image is displayed to a designated position. When the user taps the displayed blackboard image, for example, the display control is performed such that a size of the blackboard image changes. Note that when a setting change of the position and the size of the blackboard image is performed by performing such operation, setting information such as the changed position and the changed size may be updated in the image processing section 12 or the like and thereafter transmitted to the terminal apparatus 40 side via the B2 communication section 19. Blackboard specification data 52 of a recording section 44 explained below may be updated as well.

The lens unit 31 is a constituent unit for generating an optical image of a subject. The lens unit 31 includes an image pickup optical system (not shown in the figure) including a plurality of optical lenses, a plurality of retaining members (not shown in the figure) configured to retain respective optical lenses of the image pickup optical system, a driving mechanism (not shown in the figure) or the like for driving to advance or retract or rotate a part of the plurality of retaining members, circuit sections (the AF section 32, the zoom section 33, etc.) for performing driving control of the driving mechanism, and the lens-side communication section 34 (in FIG. 1, abbreviated as “L communication section”). Note that, although not shown in the figure, the lens unit 31 includes a lens shutter mechanism section and the like according to necessity besides an aperture mechanism section and the like. The not-shown mechanism sections are portions not directly related to the present invention. Therefore, it is assumed that the same components as the components applied in a lens unit of an image pickup apparatus spread to the public in the past are adopted. Detailed explanation concerning the components is omitted.

The AF section 32 is a circuit section configured to receive a control signal outputted from the lens control section 14 on the body unit side and drives the driving mechanism (not shown in the figure) to thereby realize automatic focus adjustment (AF; auto focus) operation.

The zoom section 33 is a circuit section configured to receive a control signal outputted from the lens control section 14 on the body unit side and drives the driving mechanism (not shown in the figure) to thereby realize a magnification (zoom) operation.

The lens-side communication section (the L communication section) 34 is a communication section provided on the lens unit 31 side. The lens-side communication section 34 is a circuit section for transmitting and receiving a control signal, data, and the like between (the body-side first communication section 15 of) the body unit 11 and the lens unit 31.

On the other hand, in the image pickup system 1, the terminal apparatus 40 is a small personal information terminal apparatus configured to perform communication between the terminal apparatus 40 and the image pickup apparatus 10 via the communication means 71 (explained in detail below) while causing the terminal apparatus 40 and the image pickup apparatus 10 to cooperate with each other. As the terminal apparatus 40, an electronic apparatus spread to the public and put to practical use in the past such as a personal computer (a desktop PC, a notebook PC, or a tablet PC) or a smartphone is used. In the terminal apparatus 40 of these general forms, by applying an image pickup program of the embodiment of the present invention, the image pickup system 1 of the embodiment of the present invention is configured.

Note that the image pickup apparatus 10 includes a control section (not shown in the figure) configured to supervise the entire image pickup apparatus 10 and individually control each of internal constituent units and the like of the image pickup apparatus 10.

The terminal apparatus 40 includes a terminal-side first communication section 41 (in FIG. 1, abbreviated as “D1 communication section”), a terminal-side display section 42 (in FIG. 1, “terminal-side” is omitted; hereinafter referred to accordingly), a terminal-side operation section 43 (in FIG. 1, “terminal-side” is omitted; hereinafter referred to accordingly), a terminal-side recording section 44 (in FIG. 1, “terminal-side” is omitted; hereinafter referred to accordingly), a terminal-side image processing section 45 (in FIG. 1, “terminal-side” is omitted; hereinafter referred to accordingly), a terminal-side second communication section 46 (in FIG. 1, abbreviated as “D2 communication section”), and a position-information clock-information section 47.

The terminal-side first communication section (the D1 communication section) 41 is a first communication section provided on the terminal apparatus 40 side. The terminal-side first communication section 41 is a circuit section for transmitting and receiving various data such as image data and blackboard specification data between the terminal apparatus 40 and (the body-side second communication section 19 of) the body unit 11.

The display section 42 is a display device of a general form, which is applied in a PC or the like, configured to display various kinds of information using characters, images, and the like in the terminal apparatus 40.

The operation section 43 is an input operation device configured to receive operation by the user in the terminal apparatus 40. As a specific form of the operation section 43, there are, for example, an input device such as a keyboard and a pointing device such as a mouse, a trackball, a joystick, a touch panel (a touch screen), a pen tablet, a touch pad, a track pad, or a joy pad. The operation section 43 is an input operation device of a general form applied in a PC or the like.

The recording section 44 is a storage device configured to store various kinds of information as electronic data in the terminal apparatus 40. As a specific form of the recording section 44, there are, for example, a semiconductor memory that performs temporary storage besides a storage device including a semiconductor, a magnetic storage device such as a hard disk device, and the like. The recording section 44 is a storage device of a general form applied in a PC or the like.

Note that the recording section 44 includes a recording region where various data such as construction work design drawing data 51, the blackboard specification data 52, and image pickup apparatus specification data 53 are stored.

The construction work design drawing data 51 is an information data group including peculiar data including various materials concerning recording target construction work and the like besides design drawings, design specifications, and the like of the recording target construction work (a recording target event) and the like. The construction work design drawing data 51 is, for example, data prepared in another terminal apparatus, accumulated in the external server 60 or the like, and downloaded through the network 70 besides data prepared in the terminal apparatus 40.

The blackboard specification data 52 is information data for a blackboard image prepared in the terminal apparatus 40. The blackboard specification data 52 is prepared using the terminal apparatus 40 on the basis of information (the construction work design drawing data 51) concerning the recording target construction work and the like. The blackboard specification data 52 includes various kinds of information for designating a size and the like of a display position (a combination position) in superimposing and displaying (performing combination processing of) a blackboard image in an image displayed on the basis of image data including an object besides a template (model) image and information written in the blackboard image (situation explanation information of the recording target construction work and the like; basic information such as a date and place and various kinds of information such as a construction work name, a work name, an object name, a company name, and other memoranda). For example, the blackboard specification data 52 is prepared as a result of processing performed by the image processing section 45 or the like by receiving an operation input from the operation section 43 by the user.

The image pickup apparatus specification data 53 is peculiar data concerning a corresponding specific image pickup apparatus 10 in the image pickup system 1, for example, peculiar data such as a serial number and various specification data of the image pickup apparatus 10, in particular, focal length information of the image pickup optical system (not shown in the figure) included in the lens unit 31, light receiving surface size information of the image pickup device (not shown in the figure) included in the image pickup section 13, (angle-of-view information calculated from a lens focal length and a device size), information concerning a recording image size, and the like.

The image processing section 45 is a circuit section configured to perform, for example, display control processing for causing the display section 42 to display various kinds of information as appropriate besides various kinds of data processing concerning image data, for example, preparation processing for the blackboard specification data 52 in the terminal apparatus 40. Note that the image processing section 45 also has the same function as the function of the image processing section 12 of the body unit 11. That is, the image processing section 45 also has a function of performing resolution determination processing and the like in addition to various kinds of image editing processing (combined image preparation processing, file preparation processing, etc.).

The terminal-side second communication section (the D2 communication section) 46 is a second communication section provided on the terminal apparatus 40 side. The terminal-side second communication section 46 is a circuit section for transmitting and receiving various data between the terminal apparatus 40 and the external server 60 via the network 70.

The position-information clock-information section 47 is a circuit section configured to acquire or generate position information of the terminal apparatus 40, information concerning present time, and the like.

Note that the terminal apparatus 40 includes a control section (not shown in the figure) configured to supervise the entire terminal apparatus 40 and individually control each of internal constituent units and the like of the terminal apparatus 40.

The external server 60 is a storage apparatus including a storage region or the like for storing various kinds of information such as construction work design drawing data 61, blackboard specification data 62, and image data 63 as electronic data. The external server 60 is electrically connected to the image pickup system 1 by wireless communication means or wired communication means via the existing network (computer network) 70 such as the Internet or a local area network.

Note that the construction work design drawing data 61 is the same as the construction work design drawing data 51 of the terminal apparatus 40. Similarly, the blackboard specification data 62 is the same as the blackboard specification data 52 of the terminal apparatus 40. The image data 63 is image data acquired by the image pickup apparatus 10, image data of a form obtained by applying various kinds of processing (combination processing of a blackboard image, etc.) to the image data, and the like. The construction work design drawing data 61, the blackboard specification data 62, the image data 63, and the like are data uploaded from the terminal apparatus 40 or another terminal apparatus via the network 70.

Note that, as explained above, data can be transmitted and received between the image pickup apparatus 10 and the terminal apparatus 40 by the predetermined communication means 71. As the communication means 71, wired cable communication means (e.g., a universal serial bus (USB)) can be applied as shown in FIG. 2 besides wireless communication means (e.g., near field radio communication (NFC), a wireless LAN (wireless local area network), or Bluetooth®) performed using the body-side second communication section 19 and the terminal-side first communication section 41.

It is assumed that the other components in the image pickup apparatus 10 and the image pickup system 1 applied with the image pickup apparatus 10 of the present embodiment include the same components as the components of respective general electronic apparatuses such as an image pickup apparatus, a terminal apparatus, and an external server in the past. Explanation of the components is omitted.

An overview of action performed in the image pickup apparatus 10 of the present embodiment and the image pickup system 1 applied with the image pickup apparatus 10 configured as explained above is explained below.

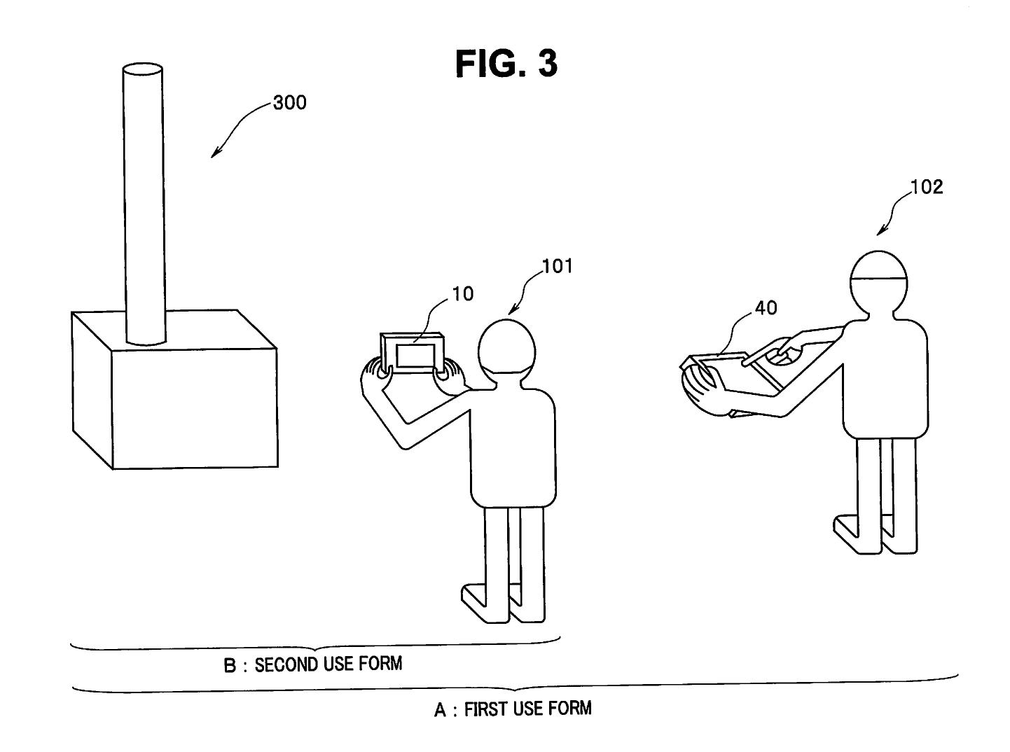

FIG. 3 is a conceptual diagram showing a state at a time when recording operation of recording target construction work or the like is performed using the image pickup system of the present embodiment.

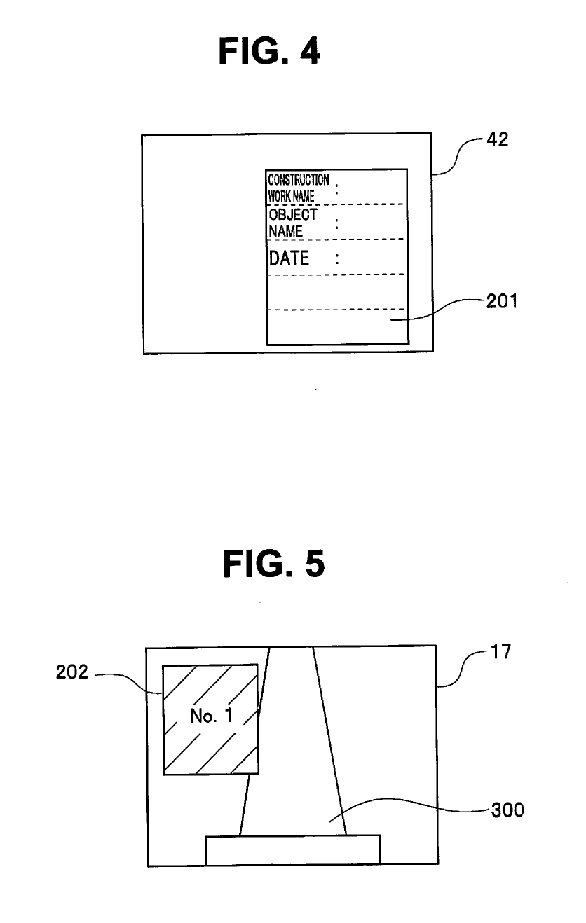

FIG. 4 is a diagram showing an example of a display form of blackboard specification data prepared in the terminal apparatus in the image pickup system of the present embodiment.

FIG. 5 is a diagram showing an example of a display form of a simple blackboard image based on blackboard specification data superimposed and displayed on a live-view image in the image pickup apparatus in the image pickup system of the present embodiment.

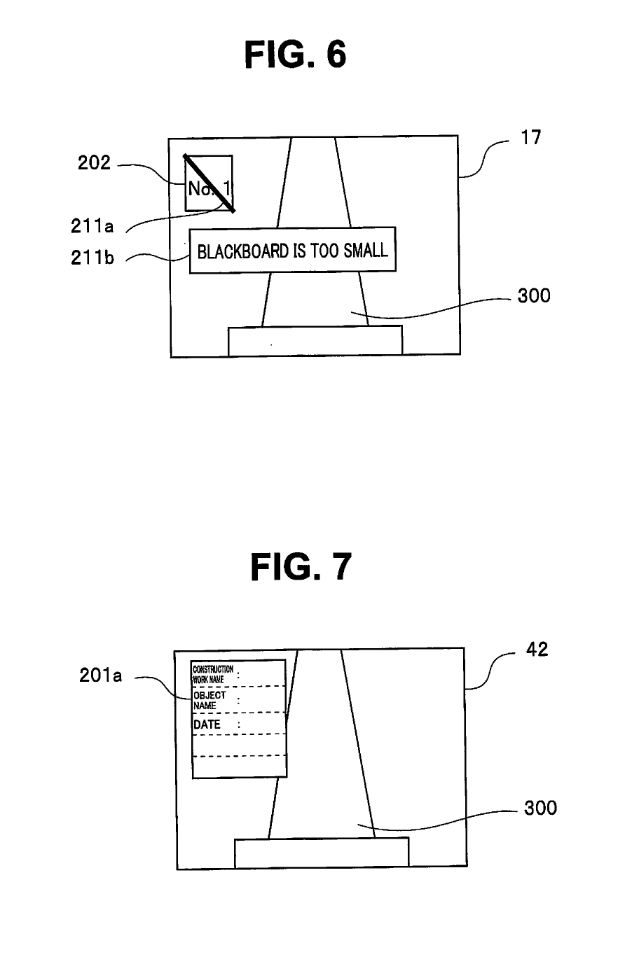

FIG. 6 is a diagram showing an example of a display form of the blackboard specification data superimposed and displayed on the live-view image in the image pickup apparatus in the image pickup system of the present embodiment and an example of a warning display appearing when setting of a blackboard image size by the blackboard specification data is too small.

FIG. 7 is a diagram showing an example of a display form of a combined image attached with a blackboard image displayed in the terminal apparatus on the basis of blackboard specification data corresponding to image data acquired in the image pickup apparatus in the image pickup system of the present embodiment.

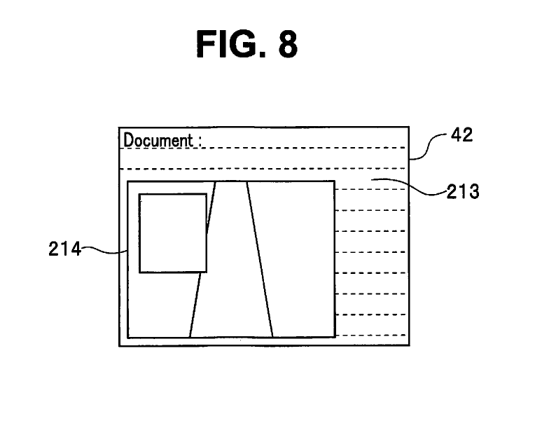

FIG. 8 is a diagram showing an example of a recording report prepared using the image pickup system of the present embodiment.

As use forms of the image pickup system 1 of the present embodiment, roughly speaking, two kinds of use forms explained below are conceivable.

First, in an indoor facility (hereinafter abbreviated as office) located in a place different from a site of recording target construction work or the like (hereinafter simply abbreviated as site), a plurality of blackboard specification data 52 respectively corresponding to a plurality of objects are prepared concerning the plurality of objects using the terminal apparatus 40 according to a schedule planned in advance. The plurality of blackboard specification data 52 is saved in the recording section 44 of the terminal apparatus 40 (see FIG. 2).

A state at a time when desired blackboard specification data 52 is prepared using the terminal apparatus 40 is shown in FIG. 4.

First, the user causes the display section 42 of the terminal apparatus 40 to display a template image 201 of a blackboard image. The user writes predetermined information (situation explanation information of recording target construction work or the like; basic information such as a date and a place and various kinds of information such as a construction work name, a work name, an object name, a company name, and other memoranda) and the like in predetermined positions in the template image 201.

The user performs this information input work using, for example, the operation section 43 of the terminal apparatus 40. Note that, when the information input work is performed, the template image 201 can be expanded in the display screen and displayed slightly larger such that an input to the template image of the blackboard image is easily performed.

Note that the information input work can be automatic input work explained below besides manual input work by the user. The predetermined information is usually accumulated in the external server 60 in advance as the construction work design drawing data 61 or the like. Therefore, the terminal apparatus 40 can access the external server 60 and download and use the predetermined information. The predetermined information downloaded to the terminal apparatus 40 may be automatically inputted to a field of a corresponding item in the template image 201 of the blackboard image for each of predetermined items.

When the blackboard specification data 52 is prepared, a position and a size of display of the blackboard image can also be designated in a display screen of image data including a corresponding recording object. It is possible to assume in advance according to a recording object whether it is appropriate to form a vertically long image or a horizontally long image. Therefore, it is possible to designate vertical position setting or horizontal position setting during acquisition of image data.

The blackboard specification data 52 prepared in this way is saved in the recording section 44 of the terminal apparatus 40 first. Besides, the blackboard specification data 52 may be transferred to the image pickup apparatus 10 in advance and saved in the recording section 20 of the image pickup apparatus 10. Further, at the same time, the blackboard specification data 52 may be uploaded to the external server 60.

The work up to this stage, that is, the preparing and saving work of the blackboard specification data 52 is work common to both of the two kinds of use forms.

Thereafter, in a first use form, the user carries out both of the image pickup apparatus 10 and the terminal apparatus 40 to the site of the recording target construction work or the like (hereinafter simply abbreviated as site) and uses the image pickup apparatus 10 and the terminal apparatus 40 while causing the image pickup apparatus 10 and the terminal apparatus 40 to cooperate each other in the site.

In this case, as explained above, the blackboard specification data 52 is saved in the terminal apparatus 40. When the blackboard specification data is transferred to the image pickup apparatus 10 in advance, the same blackboard specification data is saved in the image pickup apparatus 10 as well. Further, the blackboard specification data is sometimes saved in the external server 60 as well.

Note that, in the first use form, the blackboard specification data only has to be saved at least in the terminal apparatus 40.

However, when either one or both of the image pickup apparatus 10 and the terminal apparatus 40 are capable of communicating with the external server 60 via the network 70 (in this case, the Internet), the blackboard specification data only has to be saved in either one of the image pickup apparatus 10, the terminal apparatus 40, and the external server 60.

That is, when the blackboard specification data is present in only the image pickup apparatus 10, the blackboard specification data is used in the image pickup apparatus 10 as it is, transferred to the terminal apparatus 40 from time to time, and used by the image pickup apparatus 10 and the terminal apparatus 40 in cooperation with each other.

When the blackboard specification data is present in only the terminal apparatus 40, the blackboard specification data is transferred from the terminal apparatus 40 to the image pickup apparatus 10 from time to time according to necessity. The terminal apparatus 40 and the image pickup apparatus 10 perform work in cooperation with each other.

When the blackboard specification data is present in only the external server 60, one of the image pickup apparatus 10 and the terminal apparatus 40 downloads the blackboard specification data from the external server 60 and transfers the blackboard specification data to the other of the image pickup apparatus 10 and the terminal apparatus 40. The image pickup apparatus 10 and the terminal apparatus 40 perform work in cooperation with each other.

On the other hand, after preparing the blackboard specification data 52, in a second use form, the user takes out only the image pickup apparatus 10, in which the blackboard specification data is transferred and saved, to the site and uses the image pickup apparatus 10 while leaving the terminal apparatus 40 in the office.

In this case, after preparing the blackboard specification data 52 in the office, it is necessary to transfer the blackboard specification data 52 to the image pickup apparatus 10 in advance and record the blackboard specification data 52 in the recording section 20 of the image pickup apparatus 10.

However, in the second use form, if the image pickup apparatus 10 is capable of communicating with the external server 60 via the network 70 (the Internet), the blackboard specification data does not always need to be transferred to the image pickup apparatus 10. For example, even if the user goes to the site without transferring the blackboard specification data to the image pickup apparatus 10, the user can download the blackboard specification data from the external server 60 using the image pickup apparatus 10 in the site. In this case, the user may download the blackboard specification data every time the user performs image pickup operation or may collectively download a plurality of blackboard specification data that user needs to use.

Note that, to avoid complicated explanation, it is assumed that setting of the image pickup apparatus 10 and the terminal apparatus 40 are under conditions explained below.

First, in the case of the first use form, it is assumed that the blackboard specification data is saved in the terminal apparatus 40. In the case of the second use form, it is assumed that the blackboard specification data is saved in the image pickup apparatus 10. Therefore, in the following explanation, in both the cases of the first use form and the second use form, the user does not perform connection operation to the external server 60 using the image pickup apparatus 10 or the terminal apparatus 40 in the site.

As a situation of the site, a situation shown in FIG. 3 is assumed. That is, when a recording object 300 is present in the site of the recording target construction work or the like, a first user 101 holds the image pickup apparatus 10 and performs an image pickup operation of the recording object 300. A second user 102 holds the terminal apparatus 40 and supports the image pickup operation by the first user 101.

In this case, in the first use form, the first user 101 (the image pickup apparatus 10) and the second user 102 (the terminal apparatus 40) are present in the site (a sign A in FIG. 3). On the other hand, in the second use form, only the first user 101 (the image pickup apparatus 10) is present in the site (a sign B in FIG. 3).

Note that, in FIG. 3, in the case of the first use form, a situation is shown in which the two users (101 and 102) respectively hold the image pickup apparatus 10 and the terminal apparatus 40. However, the first use form is not limited to this form. For example, even in the first use form, a form may be conceived in which only one user is present and the user alternately uses the image pickup apparatus 10 and the terminal apparatus 40.

In the site, in the case of the first use form, first, the first user 101 starts the image pickup apparatus 10 and directs the image pickup apparatus 10 to the recording object 300. Then, a normal live-view image is displayed on the display section 17 of the image pickup apparatus 10.

At the same time, the second user 102 operates the terminal apparatus 40 to cause the display section 42 to display blackboard specification data corresponding to the recording object 300 and performs operation for transferring the blackboard specification data from the terminal apparatus 40 to the image pickup apparatus 10. That is, in this case, the second user 102 repeats operation for acquiring, every time the second user 102 performs an image pickup operation of a desired recording object, blackboard specification data corresponding to the recording object from the terminal apparatus 40.

Then, in the display section 17 of the image pickup apparatus 10, a blackboard image 202 based on the transferred blackboard specification data is displayed in a form in which the blackboard image 202 is superimposed on a live-view image. FIG. 5 is an example of the live-view image displayed on the display section 17 of the image pickup apparatus 10 at this point.

On the other hand, in the site, in the case of the second use form, first, the first user 101 operates the image pickup apparatus 10 to select blackboard specification data corresponding to the recording object 300. Then, a blackboard image (a simplified version) based on the blackboard specification data is superimposed and displayed on a live-view image in a preset size in a preset position. The display of the display section 17 of the image pickup apparatus 10 in this case is the same as the example shown in FIG. 5.

The blackboard image 202 displayed on the image pickup apparatus 10 side has, as shown in FIG. 5, a simplified display form formed by only a frame image added with a specific number corresponding to predetermined blackboard specification data.

In the image pickup apparatus 10, the display form of the blackboard image based on the blackboard specification data is such a simplified form because, first, since the display section 17 of the image pickup apparatus 10 is small, even if all kinds of detailed information is displayed on the display section 17, the detailed information cannot be discriminated on the display screen and, second, since reading and display of all kinds of information included in the blackboard specification data is an overload for circuit sections related to image display such as the image processing section 12 and the display control section 24 of the image pickup apparatus 10, an information amount in the display should be reduced in order to reduce the load on the circuit sections.

At this point, the first user 101 of the image pickup apparatus 10 can discriminate, with a specific number displayed on the blackboard image 202, whether the displayed blackboard image 202 corresponds to correct blackboard specification data corresponding to the recording object 300. That is, the first user 101 can confirm content of image specification data corresponding to the specific number by causing the terminal apparatus 40 held by the second user 102 to display the content. In the image pickup apparatus 10, for example, by tapping a region on the display screen corresponding to the displayed blackboard image 202 in FIG. 3 or operating a predetermined operation member such as an OK button (not shown in the figure), the first user 101 can switch a display form to a display form in which detailed information concerning the displayed blackboard image 202 can be confirmed using the entire display screen of the display section 17. The first user 101 can immediately return the confirmation display to the display state shown in FIG. 5 with one action operation or the like on a predetermined operation member.

Subsequently, the first user 101 performs operation for adjusting a position, a size, and the like of the blackboard image 202 in the display screen while viewing a live-view image on the display section 17 of the image pickup apparatus 10. This adjustment operation is work common to the first use form and the second use form.

That is, the adjustment operation is operation for adjusting the blackboard image 202 taking into account, for example, whether the position and the size of the blackboard image 202 are a position and a size that do not hide the recording object 300 in the display screen. The adjustment operation is performed using a predetermined operation member, a touch panel, or the like in the operation section 18 of the image pickup apparatus 10. Note that, in the first use form, the second user 102 stays on standby during the adjustment operation by the first user 101.

Note that, in the adjustment operation, for example, a frame size (also referred to as blackboard image size) of the blackboard image 202 in the display screen is sometimes set too small compared with a set recording image size.

In this case, depending on the set recording image size, resolution (an identification ability of various kinds of information (character information) described in a blackboard image) of the blackboard image 202 decreases. In the image pickup apparatus 10 in the present embodiment, a minimum value of a blackboard image size is specified according to the setting of the recording image size taking into account this fact. In the adjustment operation, when the set frame image size information of the blackboard image 202 is smaller than the specified minimum size value (is set too small) as a result of performing a setting change concerning the size of the blackboard image 202, warning displays 211a and 211b shown in FIG. 6 are performed in the image display section 17 of the image pickup apparatus 10.

The warning display 211a shown in FIG. 6 is a display example indicating that the blackboard image size is inappropriate and shows an example in which an oblique line for cancelling the frame image region of the blackboard image 202 is displayed. The warning display 211b shown in FIG. 6 is an example in which inappropriateness of the blackboard image size is indicated by a character string.

The warning display is, for example, display control performed by the display control section 24 in response to a determination result by the resolution determining section 23. The display control section 24 may further additionally perform display for facilitating resetting operation of the blackboard image size simultaneously with performing the warning display.

When such adjustment operation is performed, new blackboard specification data reflecting an adjustment result of the adjustment operation is generated. The new blackboard specification data updates the old data. The new blackboard specification data is recorded in the recording section 20 of the image pickup apparatus 10.

The screen setting (setting of a vertical position or a horizontal position) may be changed according to a situation of the site. The image pickup apparatus 10 in the present embodiment includes the sensor section 16 configured to automatically detect a posture during execution of the image pickup operation. Therefore, when a screen setting (vertical position or horizontal position setting) corresponding to a posture detection result by the sensor section 16 at the time when the image pickup operation is executed is different from screen setting designated in advance (more specifically, for example, when an image pickup operation in a horizontal position is executed when the vertical position setting is designated), data concerning the screen setting in the blackboard specification data is automatically updated.

Note that, when the adjustment before the image pickup operation is performed in the site as explained above, when the image pickup operation is executed in screen setting different from the screen setting designated in advance, concerning the position and the size of the blackboard image, display is automatically switched such that the position and the size of the blackboard image change to an appropriate position and an appropriate size according to the screen setting. The user only has to perform fine adjustment as appropriate while viewing the display.

When the adjustment of the blackboard image 202 is finished in this way, the first user 101 executes image acquisition operation (image pickup operation) by the image pickup apparatus 10. The image pickup apparatus 10 receives the image acquisition operation and executes a normal image acquiring operation. Then, normal image data is acquired. The acquired image data is recorded in the recording section 20. At this point, blackboard specification data corresponding to the image data is recorded in association with the image data.

In this case, the blackboard specification data corresponding to the image data may be respectively recorded in forms of separate files or the image data and the corresponding blackboard specification data may be recorded as an integrated one file. When the image data and the blackboard specification data are recorded in the separate file forms, for example, in tag data added to a header portion of the image data, association only has to be performed by, for example, adding information indicating that the blackboard specification data corresponding to the tag data is present. When the image data and the blackboard specification data are recorded as one file, for example, the blackboard specification data only has to be included in a header section of the image data and recorded.

A plurality of image data acquired by the image pickup apparatus 10 are classified with respect to a plurality of folders generated on the basis of any item (e.g., a date, a construction work name, and an object name) information of the associated blackboard specification data and recorded in the folders corresponding to the image data.

Note that, in the first use form, adjusted new blackboard specification data is recorded together with the image data on the image pickup apparatus 10 side. At the same time, the new blackboard specification data and the image data corresponding to the new blackboard specification data are transferred from the image pickup apparatus 10 to the terminal apparatus 40 as a set. Consequently, the blackboard specification data on the terminal apparatus 40 side is also updated.

In the terminal apparatus 40, predetermined image combination processing is performed on the basis of the transferred image data and the blackboard specification data corresponding to the image data. Consequently, a combined image data attached with a blackboard image is generated. An image based on the combined image data is displayed on the display section 42. A display example of the combined image attached with the blackboard image displayed on the display section 42 of the terminal apparatus 40 at this point is shown in FIG. 7.

In this way, in the case of the first use form, in the site, the user performs the acquisition of a plurality of image data and preparation of a plurality of combined image data while causing the image pickup apparatus 10 and the terminal apparatus 40 to cooperate with each other. In the case of the second use form, in the site, the user performs the acquisition of a plurality of image data and the association processing of blackboard specification data corresponding to the image data using the image pickup apparatus 10.

After ending a series of image pickup operation in the site in this way, in the case of the first use form, the user carries the image pickup apparatus 10 and the terminal apparatus 40 back to the office. In the case of the second use form, the user carries the image pickup apparatus 10 back to the office.

In the office, the user performs arrangement work for the plurality of image data acquired in the site as explained above. The arrangement work is arrangement work for acquired image data or the like performed after the recording operation of the recording target construction work or the like is performed in the site using the image pickup system 1 (see FIG. 2).

In the case of the first use form, the acquired plurality of image data, the plurality of blackboard specification data respectively corresponding to and associated with the plurality of image data, and the plurality of combined image data subjected to the combination processing and prepared on the basis of the plurality of image data (every time the image pickup operation is performed in the site) are recorded in the recording section 44 of the terminal apparatus 40.

In the case of the second use form, the acquired plurality of image data and the plurality of blackboard specification data respectively corresponding to and associated with the plurality of image data are recorded in the recording section 20 of the image pickup apparatus 10.

Therefore, in the office, in the case of the first use form, if desired image data is displayed using the terminal apparatus 40, blackboard specification data associated with the displayed image data is automatically read out and superimposed and displayed in a designated position in the image data. Alternatively, combined image data automatically prepared in the site only has to be simply displayed as it is.

A document such as a recording report shown in FIG. 8 is automatically prepared on the basis of various kinds of information included in blackboard specification data corresponding to the combined image data. Concerning the recording report prepared in this way, the user can also optionally additionally input (write) desired information to a desired item. Operation for the additional input is performed using the operation section 43 of the terminal apparatus 40.

Note that, as the recording report or the like, for example, a document of a report form including a format specified in advance is assumed.

Data of the recording report prepared in this way is recorded in, for example, the recording section 44 of the terminal apparatus 40 and may be uploaded to the external server 60.

In the office, in the case of the second use form, first, the user transfers the acquired plurality of image data and the plurality of blackboard specification data respectively corresponding to and associated with the plurality of image data from the image pickup apparatus 10 to the terminal apparatus 40 (which is placed in the office) via the communication means 71.

Thereafter, the user performs predetermined arrangement work in the terminal apparatus 40. The following arrangement work is the same as the arrangement work explained in the first use form.

Recording, classification, and arrangement work of the recording target construction work or the like performed using the image pickup apparatus 10 and the image pickup system 1 applied with the image pickup apparatus 10 of the present embodiment is briefly explained. A plurality of blackboard specification data are prepared in advance according to a schedule (blackboard specification data) planned in advance concerning a plurality of recording objects present in the recording target construction work or the like. When a plurality of image data respectively corresponding to the plurality of blackboard specification data are acquired, the blackboard specification data corresponding to the respective image data are recorded in association with the image data. A plurality of combined image data attached with blackboard images are generated on the basis of the plurality of image data acquired in this way and the plurality of blackboard specification data respectively associated with the plurality of image data. The generated plurality of combined image data attached with blackboard images are classified on the basis of predetermined items of the respective blackboard specification data and allocated and recorded in separate folders. Further, a document such as a recording report is prepared on the basis of the plurality of combined image data attached with blackboard images, the blackboard specification data respectively associated with the combined image data attached with blackboard images, and the like.

Note that, during acquisition operation of image data by the image pickup apparatus 10 in the present embodiment, the image pickup apparatus 10 is capable of calculating a dimension value of an object from image data (respective data for displaying a live-view image) acquired from time to time by the image pickup device (not shown in the figure) included in the image pickup section 13.

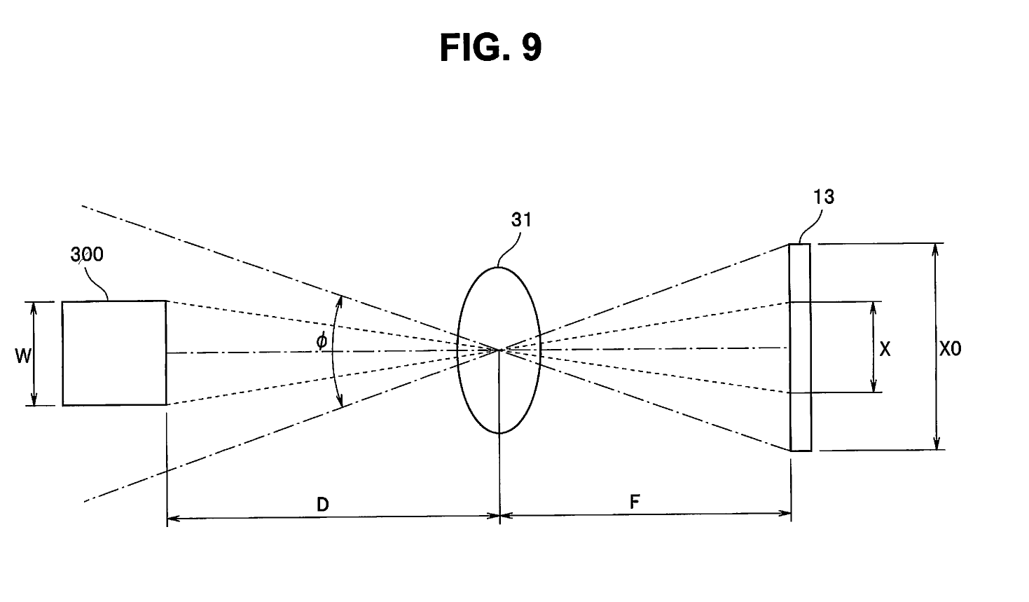

FIG. 9 is a conceptual diagram in the case in which a dimension value of an object is calculated from acquired image data in the image pickup apparatus of the present embodiment.

In order to calculate a dimension value of the object from the image data acquired by the image pickup section 13, it is possible to calculate a size W (see FIG. 9) of the object according to Equation (1) on the basis of information (e.g., a dimension value X of the object on the image pickup screen: see FIG. 9) concerning the object calculated from the image data (recorded image data or image data for live-view display) acquired by the image pickup section 13, various kinds of information (e.g., a focal length F and an angle of view ϕ of the lens unit 31 and a light receiving surface size X0 of the image pickup device of the image pickup section 13; see FIG. 9) included in the image pickup apparatus specification data 53, various kinds of information (e.g., a distance D from the image pickup apparatus 10 to the object 300: see FIG. 9) obtained by an AF operation, and the like.

W=D·X/F (1)

Note that the angle of view ϕ can be calculated by Expression (2).

ϕ≈arc tan X0/F (2)

By comparing the size W calculated in this way with various kinds of information (e.g., a design dimension value of a specific recording object extracted from the construction work design drawing data 61 or the like in advance) included in the blackboard specification data, it is possible to confirm whether the object is constructed as designed.

Therefore, by acquiring the image data of the object, the image pickup apparatus 10 of the present embodiment can confirm whether the recording target construction work or the like is executed as designed.

For that reason, a determining section for determining a comparison result of the size W of the object calculated from the image data and a design value of a size of the object may be further provided in, for example, the image processing section 12 of the image pickup apparatus 10.

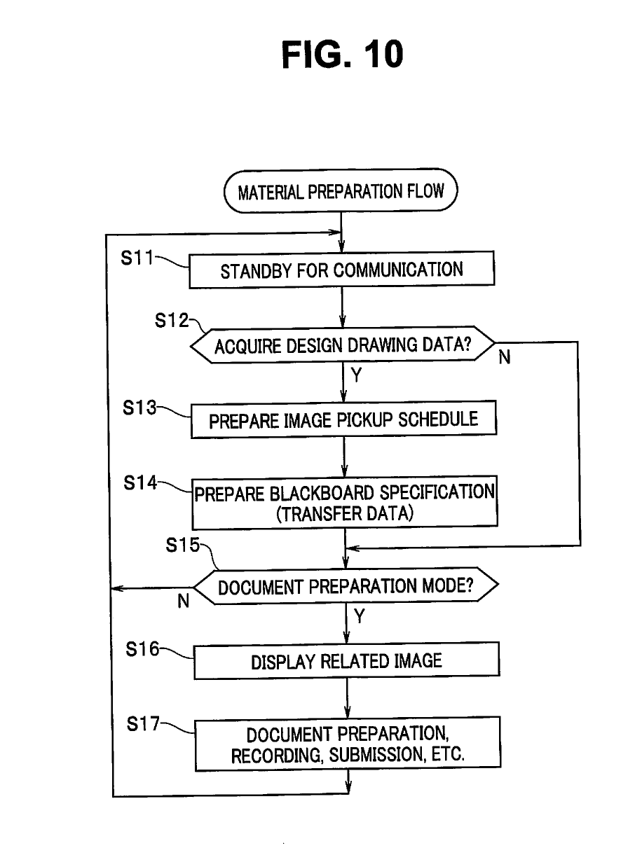

Action of the image pickup apparatus and the image pickup system applied with the image pickup apparatus of the present embodiment explained above is explained below with reference to respective flowcharts of FIGS. 10 to 14.

FIG. 10 is a flowchart of a material preparation sequence performed in the image pickup system of the embodiment of the present invention.

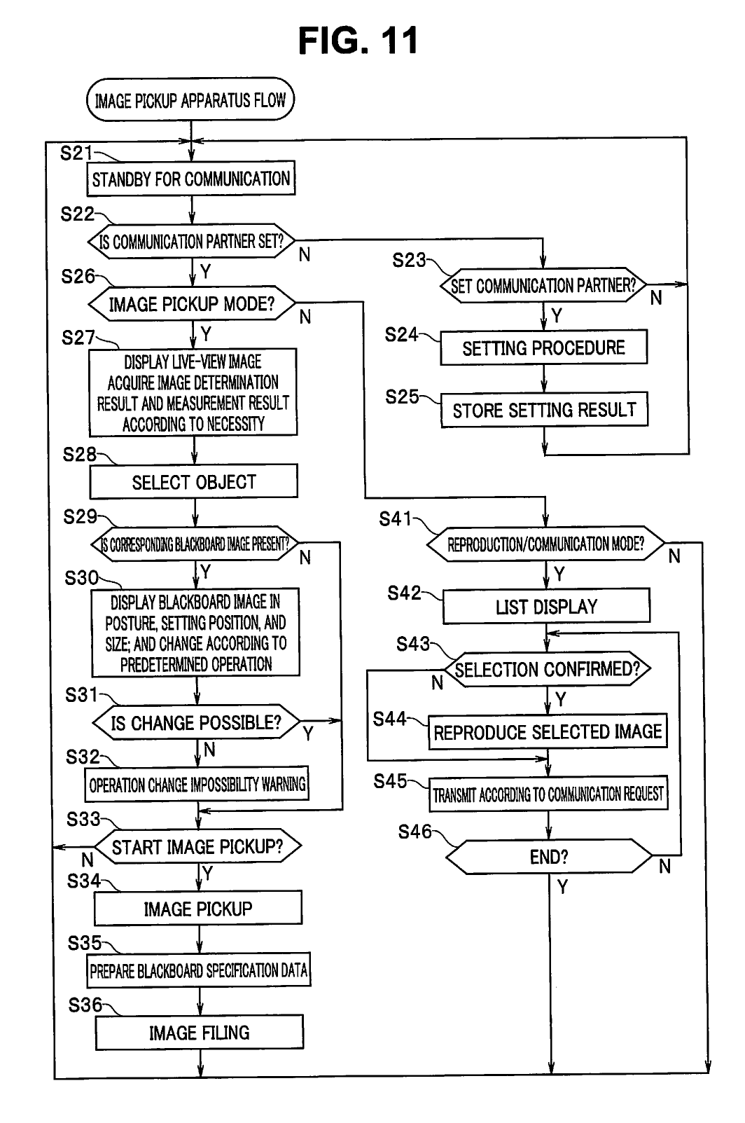

FIG. 11 is a flowchart showing action of the image pickup apparatus in the image pickup system of the embodiment of the present invention.

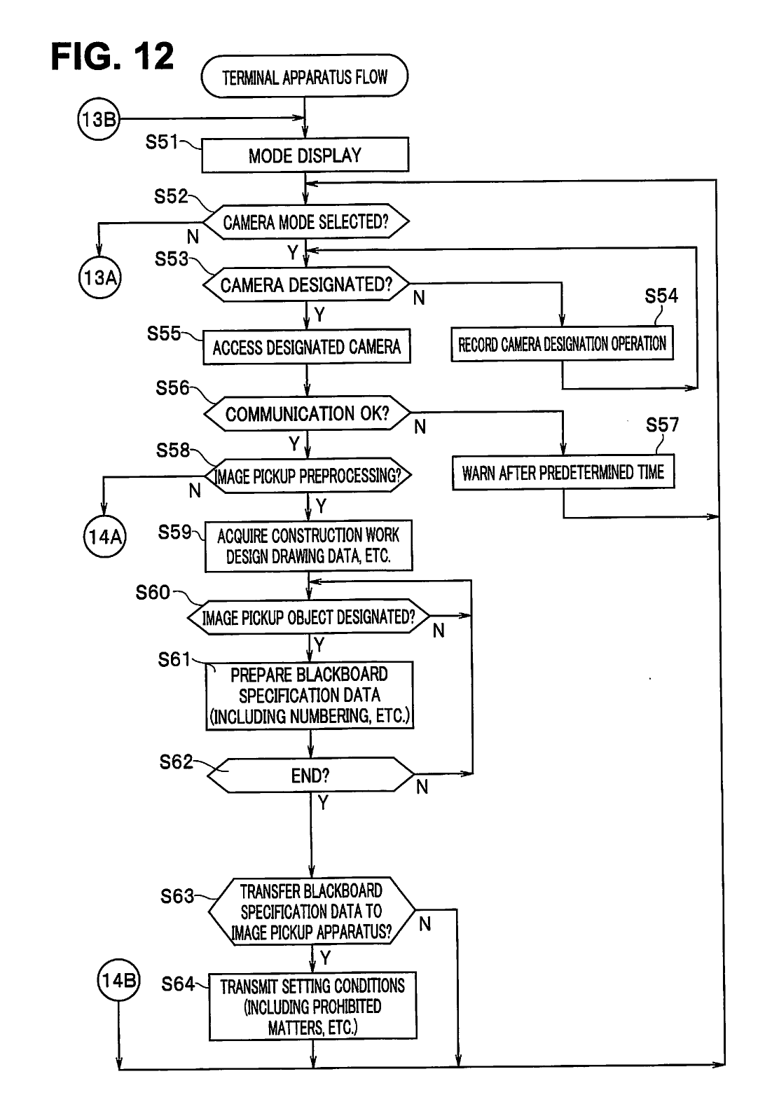

FIG. 12 is a flowchart showing action of the terminal apparatus in the image pickup system of the embodiment of the present invention.

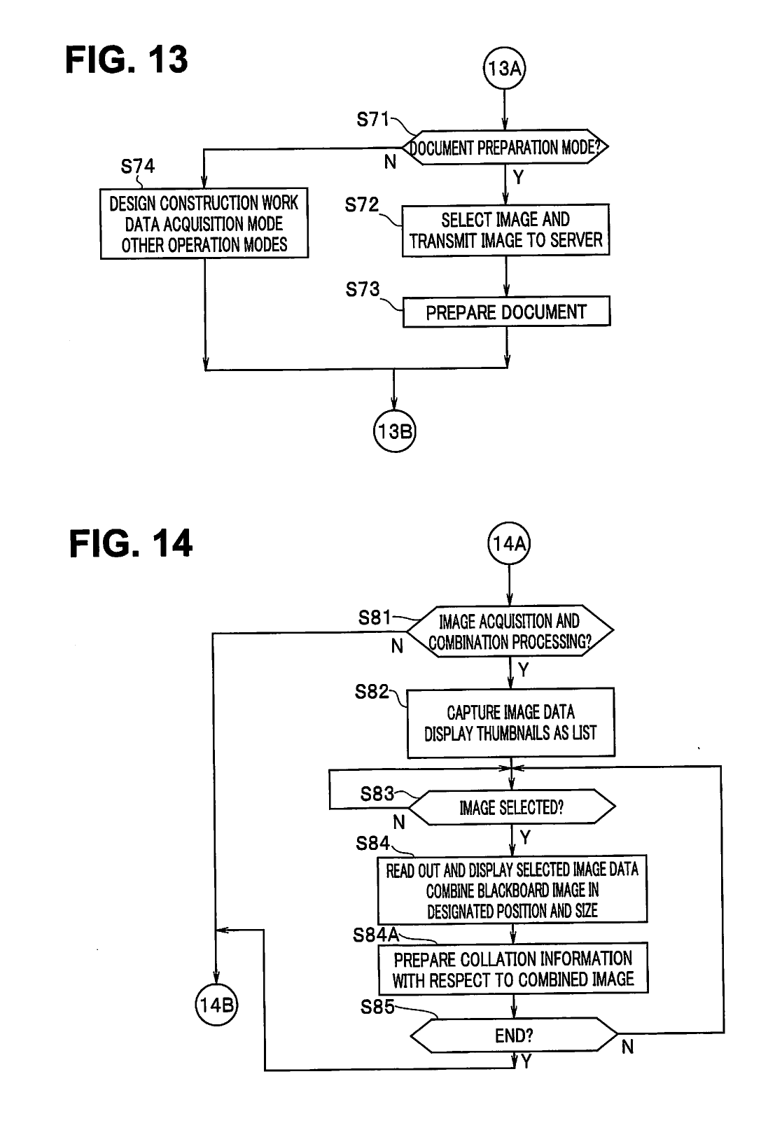

FIG. 13 is a flowchart branching from step S52 of FIG. 12.

FIG. 14 is a flowchart branching from step S58 of FIG. 12.

First, a flow of a material preparation sequence performed in the image pickup system 1 of the present embodiment is explained below with reference to FIG. 10.

First, it is assumed that the image pickup system 1 in the present embodiment is in the state shown in FIG. 2. It is assumed that, in the state, all of the image pickup apparatus 10, the terminal apparatus 40, and the external server 60 are in an operating state. It is assumed that the image pickup apparatus 10 and the terminal apparatus 40 are capable of transmitting and receiving data between the image pickup apparatus 10 and the terminal apparatus 40 via the communication means 71. It is assumed that the terminal apparatus 40 and the external server 60 are capable of transmitting and receiving data between the terminal apparatus 40 and the external server 60 via the network 70.

In this state, in step S11 of FIG. 10, the control section (not shown in the figure) of the terminal apparatus 40 is operating in a predetermined standby mode such that the control section can monitor the terminal-side first communication section 41 and perform communication with the body-side second communication section 19.

In the next step S12, the control section (not shown in the figure) of the terminal apparatus 40 confirms whether to acquire predetermined design drawing data. When acquiring the design drawing data, the control section proceeds to processing in the next step S13. When it is unnecessary to acquire the design drawing data, the control section proceeds to processing in step S15.

In step S13, the control section (not shown in the figure) of the terminal apparatus 40 prepares a series of image pickup schedule using the design drawing data acquired in the processing explained above.

Subsequently, in step S14, the control section (not shown in the figure) of the terminal apparatus 40 prepares a plurality of blackboard specification data corresponding to a necessary plurality of image data on the basis of the image pickup schedules prepared in the processing explained above. The plurality of blackboard specification data prepared in this way is transferred to the image pickup apparatus 10 via the communication means 71. Note that this transfer processing can be omitted depending on a case.

In step S15, the control section (not shown in the figure) of the terminal apparatus 40 confirms whether to execute a document preparation mode. When executing the document preparation mode, the control section proceeds to processing in the next step S16. When not executing the document preparation mode, the control section returns to the processing in step S11 explained above and stays on standby.

In step S16, the control section (not shown in the figure) of the terminal apparatus 40 performs processing for displaying a related image. The related image is, for example, an image displayed according to combined image data prepared on the basis of acquired image data and blackboard specification data corresponding to the acquired image data.

Subsequently, in step S17, the control section (not shown in the figure) of the terminal apparatus 40 executes predetermined document preparation processing on the basis of the related image and various kinds of information corresponding to the related image. Document data to be prepared is the document such as the recording report explained above. After the predetermined document is prepared, recording processing of the document is performed.

In the processing step, subsequently, online submission processing or the like may be further performed concerning the document. The online submission processing is transfer processing to another terminal apparatus present in, for example, a public office in charge or a customer company from the terminal apparatus 40 via the network 70. When the series of processing ends, the control section returns to the processing in step S11 explained above and stays on standby.

Note that, in the present embodiment, blackboard specification data preparation processing (S12 to S14) and document preparation processing (S16 and S17) are only expressly explained as the material preparation sequence. However, the material preparation sequence is not limited to these kinds of processing. When there are other kinds of processing, a sequence for dividing the processing in step S15 to the other kinds of processing only has to be formed.

Subsequently, action of the image pickup apparatus in the image pickup system in the embodiment of the present invention is explained with reference to the flowchart of FIG. 11.

First, it is assumed that, for example, a power supply of the image pickup apparatus 10 is turned on and the image pickup apparatus 10 is started in a usable state. At this point, as shown in step S21 in FIG. 11, the control section (not shown in the figure) of the image pickup apparatus 10 starts communication standby processing between the image pickup apparatus 10 and another apparatus, for example, the terminal apparatus 40 in a background. That is, the image pickup apparatus 10 includes, at a start time, an operation mode for always standing by for communication in the background. Naturally, the operation mode can also be always turned off. That is, a communication operation mode in the image pickup apparatus 10 can be turned on and off according to necessity.

Subsequently, in step S22, the control section (not shown in the figure) of the image pickup apparatus 10 confirms whether setting for specifying another apparatus (here, the terminal apparatus 40), which should be set as a communication partner, is performed. When confirming that the setting for specifying the communication partner apparatus (the terminal apparatus 40) is not performed, the control section proceeds to processing in step S23. When confirming that the setting for specifying the communication partner apparatus (the terminal apparatus 40) is performed, the control section proceeds to processing in the next step S26.

When not confirming the setting of the communication partner in step S22 and proceeding to step S23, in step S23, the control section (not shown in the figure) of the image pickup apparatus 10 confirms whether to perform setting operation of the communication partner. When performing the setting operation of the communication partner, the control section proceeds to processing in step S24. When not performing the setting operation of the communication partner, the control section returns to the processing in step S21 explained above.

In step S24, the control section (not shown in the figure) of the image pickup apparatus 10 executes predetermined setting procedure processing for the communication partner setting. Thereafter, the control section proceeds to processing in step S25.

In step S25, the control section (not shown in the figure) of the image pickup apparatus 10 stores, in a predetermined storing section (e.g., a not-shown internal memory), a setting processing result of communication partner setting processing performed in the processing in step S24 explained above. Thereafter, the control section returns to the processing in step S21.

On the other hand, when confirming the setting of the communication partner in step S22 and proceeding to step S26, in step S26, the control section (not shown in the figure) of the image pickup apparatus 10 confirms whether an operation mode of the image pickup apparatus 10 is an image pickup mode. When the operation mode of the image pickup apparatus 10 is the image pickup mode, the control section proceeds to processing in the next step S27. When the operation mode of the image pickup apparatus 10 is set to an operation mode other than the image pickup mode, the control section proceeds to processing in step S41.

In step S27, the control section (not shown in the figure) of the image pickup apparatus 10 controls the image pickup section 13 to execute image acquisition processing and, at the same time, controls the body-side first communication section 15 to perform communication with the lens-side communication section 34 and performs driving control of the AF section 32 and the zoom section 33 via the lens control section 14. The control section (not shown in the figure) of the image pickup apparatus 10 controls the display section 17 via the display control section 24 to execute live-view image display processing.

Further, simultaneously with these kinds of processing, the control section executes a predetermined operation according to necessity. The predetermined operation is operation for executing, for example, image determination processing and measurement processing according to necessity and acquiring processing results of the processing.

The image determination processing is processing for referring to image data and blackboard specification data acquired by the image pickup device of the image pickup section 13 and determining whether a main subject in the image data is a desired recording object.

The measurement processing is processing for calculating, on the basis of image data acquired by the image pickup device of the image pickup section 13, basic information (information such as a lens focal length, a device size, and an angle of view) of the image pickup apparatus 10, distance information to the object obtained by an AF operation, and the like, a dimension of a predetermined part of the object formed in the image data. Data of result of the measurement is stored in a predetermined region of the recording section 20 or the like.

Subsequently, in step S28, the control section (not shown in the figure) of the image pickup apparatus 10 selects an object on which an image pickup operation should be performed.

In step S29, the control section (not shown in the figure) of the image pickup apparatus 10 confirms whether data of a blackboard image included in blackboard specification data corresponding to the object selected in step S28 explained above is present. When confirming that the data of the blackboard image corresponding to the object is present, the control section proceeds to processing in the next step S30. When the data of the blackboard image corresponding to the object is absent, the control section skips step S30 and proceeds to processing in step S31.

In step S30, the control section (not shown in the figure) of the image pickup apparatus 10 displays blackboard images of various forms prepared on the basis of blackboard specification data including posture information detected on the basis of an output from the sensor section 16 and various kinds of preset information (information such as a setting position of the blackboard image in the display screen and a size of the blackboard image). At the same time, the user operates the operation section 18, whereby various setting changes for the blackboard image (mainly changes of a position in a screen, a size, etc.) are performed.

In step S31, the control section (not shown in the figure) of the image pickup apparatus 10 confirms whether the setting change in step S30 explained above is possible. When the setting change is possible, the control section skips processing in step S32 and proceeds to processing in the next step S33. When the setting change is impossible, the control section proceeds to processing in the next step S32.

Here, the setting change is, for example, a setting change concerning the size of the blackboard image. As explained above, when the blackboard image size in the display screen is inappropriate (e.g., too small) with respect to the recording image size set in the image pickup apparatus 10, it is determined that the setting change is impossible (invalid).

In step S32, the control section (not shown in the figure) of the image pickup apparatus 10 executes a warning display indicating that the setting change operation performed in the processing in step S30 is impossible. An example of the warning display is, for example, the warning display shown in FIG. 6.

Subsequently, in step S33, the control section (not shown in the figure) of the image pickup apparatus 10 confirms whether an instruction signal for starting an image pickup operation is generated. The image pickup operation start instruction signal is, for example, a shutter release signal or the like generated by operation of a shutter release operation member. When the warning display is displayed in the processing in step S32 explained above, naturally, the user does not perform the image pickup operation start instruction. That is, when confirming the generation of the image pickup operation start instruction signal, the control section proceeds to processing in step S34. When not confirming the generation of the image pickup operation start instruction signal, the control section returns to the processing in step S21 and repeats the subsequent processing.

When confirming the generation of the image pickup operation start instruction signal and proceeding to the processing in step S34, in step S34, the control section (not shown in the figure) of the image pickup apparatus 10 executes predetermined image pickup operation processing. The image pickup operation processing is the same as the processing performed by the general image pickup apparatus in the past.

Subsequently, in step S35, the control section (not shown in the figure) of the image pickup apparatus 10 performs, concerning currently set blackboard specification data, predetermined data processing for associating the blackboard specification data with the image data acquired in the image pickup operation processing in step S34 explained above. The predetermined data processing is, for example, preparation processing of tag data for attaching content of the blackboard specification data to a header section of the image data.

Subsequently, in step S36, the control section (not shown in the figure) of the image pickup apparatus 10 executes image filing processing for filing the image data acquired in the image pickup operation processing in step S34 explained above and the currently set blackboard specification data in association with each other. As the image filing, there are various file forms such as a form of recording the image data and the blackboard specification data as one file and a form of combining the image data and the blackboard specification data and recording the image data and the blackboard specification data as combined image data besides a form of recording the image data and the blackboard specification data as separate files associated with each other. When the combined image data is recorded, the collation-information preparing section 25 prepares collation information for a combined image and records the collation information in association with the combined image data. Consequently, it is possible to obtain and verify collation information for verifying falsification of the combined image data. Thereafter, the control section returns to the processing in step S21 explained above and repeats the subsequent processing.

On the other hand, when the operation mode of the image pickup apparatus 10 is set to an operation mode other than the image pickup mode in the processing in step S26 explained above, when proceeding to processing in step S41, in step S41, the control section (not shown in the figure) of the image pickup apparatus 10 confirms whether the operation mode of the image pickup apparatus 10 is set to a reproduction/communication mode. When the operation mode of the image pickup apparatus 10 is not the reproduction/communication mode, the control section returns to the processing in step S21 explained above.

Note that, in the processing sequence of FIG. 11 explained above, an example is shown in which the control section returns to the processing in step S21 when the operation mode of the image pickup apparatus 10 is not the reproduction/communication mode. However, the processing sequence is not limited to this form. For example, when the image pickup apparatus 10 has another operation mode other than the reproduction/communication mode, the control section only has to shift to the other operation mode.

When the operation mode of the image pickup apparatus 10 is the reproduction/communication mode in the processing in step S41, when proceeding to processing in step S42, in step S42, the control section (not shown in the figure) of the image pickup apparatus 10 performs, using the display section 17, list display concerning the plurality of image data recorded in the recording section 20. The user performs predetermined operation on the list display performed on the display section 17 and performs selection operation for selecting desired image data.

In the next step S43, the control section (not shown in the figure) of the image pickup apparatus 10 confirms whether a predetermined selection signal is generated when the user performs the selection operation. When confirming the generation of the predetermined selection signal, the control section proceeds to processing in the next step S44. When not confirming generation of the predetermined selection signal, the control section proceeds to processing in step S45.

In step S44, the control section (not shown in the figure) of the image pickup apparatus 10 executes selected image reproduction processing for causing the display section 17 to display an image (a selected image) based on image data corresponding to a predetermined selection signal.

In step S45, when confirming the communication request signal, the control section (not shown in the figure) of the image pickup apparatus 10 transmits the image data of the selected image being reproduced and displayed to the terminal apparatus 40. Note that, when not confirming the communication request signal, the control section proceeds to processing in the next step S46.

In step S46, the control section (not shown in the figure) of the image pickup apparatus 10 confirms generation of an instruction signal for ending the processing sequence (referred to as end instruction signal), for example, a switching signal from the reproduction/communication mode to another operation mode. When confirming the end instruction signal, the control section returns to the processing in step S21 explained above. When not confirming the end instruction signal, the control section returns to the processing in step S43 explained above and repeats the subsequent processing.

Note that, although illustration is omitted to avoid complicating the drawings, when confirming, for example, a power supply state OFF signal as the end instruction signal in the processing in step S46 explained above, the control section ends the series of processing sequence of the image pickup apparatus 10.

Action of the terminal apparatus in the image pickup system of the embodiment of the present invention is explained below with reference to the flowcharts of FIGS. 12 to 14.

First, it is assumed that, for example, a power supply of the terminal apparatus 40 is turned on and the terminal apparatus 40 is started in a usable state. At this point, as shown in step S51 in FIG. 12, the control section (not shown in the figure) of the terminal apparatus 40 displays a list of operable various operation modes on the display screen of the display section 42.

In step S52, the control section (not shown in the figure) of the terminal apparatus 40 confirms whether a camera mode among the various operation modes is selected. The camera mode is a mode for performing communication between the terminal apparatus 40 and the image pickup apparatus 10 and executing various operations in cooperation with the image pickup apparatus 10. Note that, in the following explanation, for simplification, the image pickup apparatus 10 is sometimes simply referred to as a camera.

When confirming in step S52 that the camera mode is selected, the control section proceeds to processing in the next step S53. When confirming in step S52 that a mode other than the camera mode is selected, the control section proceeds to a processing sequence of FIG. 13 (processing in step S71) (see a sign 13A in FIGS. 12 and 13).

In step S53, the control section (not shown in the figure) of the terminal apparatus 40 confirms whether a specific image pickup apparatus 10 is already designated as a communication partner. This processing corresponds to the processing in step S22 in FIG. 11. When confirming that the image pickup apparatus 10 is already designated, the control section proceeds to processing in the next step S55. When the image pickup apparatus 10 is not designated, the control section proceeds to processing in step S54.

In step S54, the control section (not shown in the figure) of the terminal apparatus 40 receives predetermined operation by the user and performs operation for designating a specific image pickup apparatus 10 set as a communication partner. The designation operation is, for example, input operation for communication connection setting (e.g., a connection ID and a password) for establishing communication between the terminal apparatus 40 and the image pickup apparatus 10. When the information input operation for the communication connection setting by the user is completed, the control section (not shown in the figure) of the terminal apparatus 40 records these kinds of information in a predetermined region or the like in the recording section 44 as electronic data. Thereafter, the control section returns to the processing in step S53.

Subsequently, in step S55, the control section (not shown in the figure) of the terminal apparatus 40 starts predetermined communication processing for communication with the designated specific image pickup apparatus 10 via the communication means 71.

Subsequently, in step S56, the control section (not shown in the figure) of the terminal apparatus 40 confirms whether communication between the terminal apparatus 40 and the designated specific image pickup apparatus 10 is established. When the communication between the terminal apparatus 40 and the designated specific image pickup apparatus 10 is established (communication OK), the control section proceeds to processing in the next step S58. When the communication between the terminal apparatus 40 and the designated specific image pickup apparatus 10 is not established (communication NG), the control section proceeds to processing in step S57.

When confirming that the communication between the terminal apparatus 40 and the image pickup apparatus 10 is not established and proceeding to the processing in step S57, in step S57, the control section (not shown in the figure) of the terminal apparatus 40 refers to the position-information clock-information section 47 and, after a predetermined time elapses, performs a predetermined warning display in the display section 42. Thereafter, the control section returns to the processing in step S32 and repeats the subsequent processing.

On the other hand, when confirming in the processing in step S56 explained above that the communication between the terminal apparatus 40 and the designated specific image pickup apparatus 10 is established and proceeding to processing in step S58, in step S58, the control section (not shown in the figure) of the terminal apparatus 40 confirms whether to perform image pickup preprocessing. The image pickup preprocessing is, for example, preparation processing for blackboard specification data. When the image pickup preprocessing is performed, the user performs input operation for starting the image pickup preprocessing from the operation section 43 of the terminal apparatus 40. When confirming to perform the image pickup preprocessing, the control section proceeds to processing in the next step S59. When confirming not to perform the image pickup preprocessing, the control section proceeds to processing sequence of FIG. 14 (processing in step S81) (see a sign 14A in FIGS. 12 and 14).

In step S59, the control section (not shown in the figure) of the terminal apparatus 40 executes the image pickup preprocessing. First, the control section (not shown in the figure) of the terminal apparatus 40 controls the terminal-side second communication section 46 to access the external server 60 through the network 70 and acquires (downloads) the construction work design drawing data 61 or the like corresponding to predetermined recording target construction work or the like from the external server 60.

Subsequently, in step S60, the control section (not shown in the figure) of the terminal apparatus 40 confirms whether a recording object is designated. The user refers to the construction work design drawing data 61 or the like acquired in the processing in step S59 explained above and performs operation for selecting and designating a desired recording object out of the construction work design drawing data 61 or the like. When confirming that the recording object is designated, the control section proceeds to processing in the next step S61. When confirming that the recording object is not designated, the control section stands by for a designation input.

Subsequently, in step S61, the control section (not shown in the figure) of the terminal apparatus 40 performs, for example, preparation of blackboard specification data concerning the recording object designated in the processing in step S60 explained above. The blackboard specification data to be prepared may be automatically prepared by capturing predetermined information from the construction work design drawing data 61. The user may optionally input necessary information.

The blackboard specification data includes information (information such as a construction work name and a location) common to the recording target construction work or the like set as a target, information (information such as an object name, a disposition position, and a size) peculiar to the recording object, and the like in addition to template image data of a blackboard image, frame image data for a simplified version of the blackboard image, and the like.

A specific number for the simplified blackboard image is included in the blackboard specification data. The specific number of the recording object may be, for example, numbered (numbers are sequentially allocated as the specific number) in preparation order of blackboard specification data prepared for each of recording objects. The user may optionally input the specific number.

Subsequently, in step S62, the control section (not shown in the figure) of the terminal apparatus 40 confirms whether to end the image pickup preprocessing. When confirming an end instruction signal for the image pickup preprocessing, the control section proceeds to processing in the next step S63. When not confirming the end instruction signal for the image pickup preprocessing, the control section returns to the processing in step S60 and repeats the subsequent processing. That is, the user can continue the designation operation of individual recording objects and the preparation work of blackboard specification data concerning the designated recording object until the user performs the operation for generating the end instruction signal for the image pickup preprocessing.

When confirming the end instruction signal for the image pickup preprocessing and proceeding to the processing in the next step S63, in step S63, the control section (not shown in the figure) of the terminal apparatus 40 confirms whether to transfer a prepared plurality of blackboard specification data to the image pickup apparatus 10. When receiving operation by the user and confirming a transfer processing instruction signal for transfer to the image pickup apparatus 10, the control section proceeds to processing in the next step S64. When not confirming the transfer processing instruction signal for transfer to the image pickup apparatus 10, the control section returns to the processing in step S52 explained above.

Subsequently, in step S64, the control section (not shown in the figure) of the terminal apparatus 40 transmits information such as various setting conditions (including prohibited matters) to the image pickup apparatus 10. Thereafter, the control section returns to the processing in step S52.

On the other hand, when confirming in the processing in step S52 explained above that a mode other than the camera mode is selected and proceeding to the processing in step S71 in FIG. 13 (a sign 13A in FIGS. 12 and 13), in step S71, the control section (not shown in the figure) of the terminal apparatus 40 confirms whether the operation mode selected in the processing in step S52 explained above (FIG. 12) is the document preparation mode. When confirming that the document preparation mode is selected, the control section proceeds to processing in the next step S72. When a mode other than the document preparation mode is selected, the control section proceeds to processing in step S74.

In step S72, the control section (not shown in the figure) of the terminal apparatus 40 receives operation by the user, causes the display section 42 to display a selected plurality of combined image data (image data obtained by combining image data acquired in the site and blackboard specification data associated with the image data; see FIG. 7) as a list, and performs processing for collectively transmitting the series of combined image data to the external server 60.

Subsequently, in step S73, the control section (not shown in the figure) of the terminal apparatus 40 executes document preparation processing. The document preparation processing is, for example, processing for preparing a recording report (a document) of a format specified in advance according to the selected series of combined image data and blackboard specification data associated with the combined image data and various kinds of information corresponding to the combined image data (predetermined information extracted from the construction work design drawing data). This recording report preparation processing is collectively performed on the basis of a plurality of combined image data and various related information related to each other in the predetermined recording target construction work or the like. Thereafter, the control section ends the series of processing and returns to the processing in step S51 of FIG. 12 explained above (see a sign 13B in FIGS. 13 and 12).

When confirming a mode other than the document preparation mode in the processing in step S71 explained above and proceeding to step S74, in step S74, the control section (not shown in the figure) of the terminal apparatus 40 executes other operation modes such as a construction work design drawing data acquisition mode. Note that these other operation modes are portions not directly related to the present invention. Therefore, explanation of the other operation modes is omitted. Thereafter, the control section ends the series of processing and returns to the processing in step S51 in FIG. 12 explained above (see a sign 13B in FIGS. 13 and 12).

On the other hand, when confirming in the processing in step S58 explained above not to perform the image pickup preprocessing and proceeding to processing in step S81 in FIG. 14 (see a sign 14A in FIGS. 12 and 14), in step S81, the control section (not shown in the figure) of the terminal apparatus 40 confirms whether to execute image acquisition and combination processing.

The image acquisition and combination processing is a series of processing for performing predetermined image combination processing and preparing combined image data attached with a blackboard image on the basis of processing for capturing a plurality of image data acquired from the image pickup apparatus 10 and a plurality of blackboard specification data associated with the plurality of image data and on the basis of the plurality of image data and the blackboard specification data captured by the processing.

When confirming an instruction for executing the image acquisition and combination processing, the control section proceeds to processing in the next step S82. When not confirming the instruction for executing the image acquisition and combination processing, the control section returns to the processing in step S51 in FIG. 12 explained above (see a sign 14B in FIGS. 14 and 12).

In step S82, the control section (not shown in the figure) of the terminal apparatus 40 accesses the image pickup apparatus 10 via the terminal-side first communication section 41 and executes processing for collectively capturing a plurality of image data recorded in the recording section 20 of the image pickup apparatus 10, blackboard specification data associated with the plurality of image data, and the like. The captured image data and the like are recorded in a predetermined storage region of the recording section 44 in the terminal apparatus 40.

After completion of this capturing processing, further, the control section (not shown in the figure) of the terminal apparatus 40 controls the recording section 44 and the display section 42 and executes thumbnail list display of the captured plurality of image data.

Subsequently, in step S83, the control section (not shown in the figure) of the terminal apparatus 40 confirms whether the user selects desired image data. When confirming a selection instruction for image data, the control section proceeds to processing in the next step S84. When not confirming the selection instruction for image data, the control section stands by for the selection instruction.

In step S84, the control section (not shown in the figure) of the terminal apparatus 40 reads out, from the recording section 44, the image data instructed to be selected in the processing in step S83 explained above, reproduces and displays the image data on the display section 42, refers to blackboard specification data associated with the image data, and superimposes and displays a predetermined blackboard image on the displayed image data in a designated position and a designated size. At the same time, the control section executes, in the image processing section 45, combination processing of the image data and a blackboard image corresponding to the image data and prepares combined image data attached with a blackboard image.

Subsequently, in step S84A, the control section prepares collation information with a collation-information preparing section (not shown in the figure) in the image processing section 45 with respect to the prepared combined image data and records the collation information in the recording section 44 in association with the combined image data.

Subsequently, in step S85, the control section (not shown in the figure) of the terminal apparatus 40 confirms whether to end the image acquisition and combination processing. When not confirming an end instruction signal for the image acquisition and combination processing, the control section returns to the processing in step S83 explained above and repeats the subsequent processing. That is, the user can perform the selection operation of image data for performing combination processing and continue the preparation work for desired combined image data attached with a blackboard image until the user performs operation for generating the end instruction signal for the image acquisition and combination processing. When confirming the end instruction signal for the image acquisition and combination processing, the control section ends the series of processing and returns to the processing in step S51 in FIG. 12 explained above (see a sign 14B in FIGS. 14 and 12).

As explained above, according to the embodiment, the terminal apparatus 40 prepares, in advance, on the basis of an information data group concerning recording target construction work (a recording target event) including a plurality of kinds of incidental information concerning a plurality of image pickup objects, a plurality of incidental information images (a plurality of blackboard specification data) respectively corresponding to the individual image pickup objects and transfers the plurality of incidental information images (the plurality of blackboard specification data) to the image pickup apparatus 10. When generating image data of the image pickup object, the image pickup apparatus 10 displays, on the display section 17, an image based on the image data and superimposes and displays a specific incidental information image corresponding to the image displayed on the display section 17 among the plurality of incidental information images in a position designated in advance in the display screen and in a size designated in advance.

In this state, when the image pickup apparatus 10 executes an image pickup operation and acquires image data, data of a blackboard image representing the incidental information image corresponding to the acquired image data is recorded in association with the image data.

The image pickup apparatus 10 transfers the image data recorded in this way and the blackboard image data associated with the image data to the terminal apparatus 40 side and causes the terminal apparatus 40 to display the image data. Then, the terminal apparatus 40 combines the displayed image data and image data of the incidental information image (the blackboard image) corresponding to the displayed image data to generate combined image data and records the combined image data.

Note that the image pickup apparatus 10 can also combine the displayed image data and the image data of the incidental information image (the blackboard image) corresponding to the displayed image data to generate the combined image data simultaneously with recording the acquired image data and the incidental information image data (the blackboard image data) corresponding to the acquired image data in association with each other.

In this case, when a set size of a blackboard image, which should be associated and combined, is inappropriate (e.g., too small) with respect to a recording image size set in the image pickup apparatus 10, the image pickup apparatus 10 performs a warning display indicating to that effect. Consequently, since the user performs resetting operation for the blackboard image, an inappropriate blackboard image is not associated. Therefore, it is possible to defer failures and surely acquire desired combined image data.

Note that a change in procedures of the respective processing sequences explained in the embodiments can be allowed as long as the change is not contrary to characteristics of the processing sequences. Therefore, for example, every time execution order of the processing steps is changed, a plurality of processing steps are simultaneously executed, or a series of processing sequence is executed with respect to the processing sequence explained above, the order of the respective processing steps may be different. That is, even if the operation flows in the claims, the specification, and the drawings are explained using “first”, “next”, and the like for convenience, this does not mean that it is essential to implement the operation flows in this order. It goes without saying that portions not affecting the essence of the invention in the respective steps configuring the operation flows can be omitted as appropriate.

Among the techniques explained above, most of the control and the functions mainly explained in the flowcharts often can be set by a software program. A computer can realize the control and the functions by reading and executing the software program. The software program is electronic data, the entire or a part of which is stored or recorded as a computer program product, in a product manufacturing process in advance, in the storage medium, the storing section, and the like, more specifically, a portable medium such as a flexible disk, a CD-ROM, or a nonvolatile memory or a storage medium such as a hard disk or a volatile memory. Separately from this, the software program can be circulated or provided during product shipment or via a portable medium or a communication line. Even after the product shipment, the user can download the software program and install the software program in a computer via a communication network, the Internet, or the like by himself or herself or install the software program in the computer from a storage medium to enable the software program to operate. Consequently, it is possible to easily realize the image pickup apparatus according to the present embodiment. The image pickup section and the display section may be separate. In this case, the present invention is an invention of a display apparatus for image pickup.

The present invention is not limited to the embodiment explained above. It goes without saying that various modifications and applications can be implemented within a range not departing from the spirit of the invention. Further, inventions in various stages are included in the embodiment. Various inventions can be extracted according to appropriate combinations in the disclosed plurality of constituent elements. For example, when the problems to be solved by the invention can be solved and the effects of the invention can be acquired even if several constituent elements are deleted from all the constituent elements described in the embodiment, a configuration from which the constituent elements are deleted can be extracted as an invention. Further, the constituent elements described in different embodiments may be combined as appropriate. The present invention is not limited by specific implementation forms of the present invention except that the present invention is limited by the appended claims.

The present invention is not limited to an image pickup apparatus specialized for an image pickup function such as a digital camera. The present invention can be widely applied to electronic apparatuses of other forms including the image pickup function, for example, various electronic apparatuses with the image pickup function such as a video camera, a cellular phone, a smartphone, an electronic notebook, an electronic dictionary, a portable information terminal, a personal computer, a tablet terminal apparatus, a game apparatus, a television receiver, a clock, and a navigation apparatus that makes use of a GPS (global positioning system).

What is claimed is:

1. An image pickup apparatus comprising:
an image pickup section configured to receive an optical image of an object and generate and output image data;
a display section configured to display an image based on the image data outputted from the image pickup section and various kinds of information;
a communication section configured to perform communication between the communication section and a terminal apparatus and acquire incidental information concerning the object; and
a display control section configured to perform processing of superimposing/displaying an image in the image displayed on the display section based on the incidental information corresponding to the image, wherein
the display control section performs display control for displaying the image based on the incidental information in a position designated in advance in a display screen of the display section.

2. The image pickup apparatus according to claim 1, further comprising an operation section configured to perform operation for changing a display position and a display size in the display screen of the image based on the incidental information, wherein
the display control section performs display control for changing the display position and the display size of the image in the display screen based on the incidental information according to the display change operation by the operation section.

3. The image pickup apparatus according to claim 2, wherein the communication section transfers, to the terminal apparatus, information concerning the display position and the display size of the image in the display screen based on the incidental information changed by the display control section according to the display change operation by the operation section.

4. The image pickup apparatus according to claim 1, further comprising a recording section configured to record the image data outputted from the image pickup section and the incidental information corresponding to the image data in association with each other.

5. The image pickup apparatus according to claim 4, further comprising a combined-image preparing section configured to combine the image data outputted from the image pickup section and image data of an incidental information image based on the incidental information corresponding to the image data to generate combined image data, wherein
the recording section records the combined image data generated by the combined-image preparing section.

6. The image pickup apparatus according to claim 5, further comprising a collation-information preparing section configured to calculate, as collation information, a detection value for detecting falsification of a combined image from the combined image data.

7. The image pickup apparatus according to claim 6, wherein the recording section records the combined image data and the collation information in association with each other.

8. The image pickup apparatus according to claim 6, wherein
the communication section transfers the combined image data to the terminal apparatus, and
in the transfer, the communication section transfers the combined image data and the collation information in association with each other.

9. The image pickup apparatus according to claim 1, wherein, when the incidental information image is superimposed and displayed in the image displayed on the display section, the display control section performs display control for displaying an image different from the incidental information image included in the image based on the image data.

10. The image pickup apparatus according to claim 9, wherein the display control section causes the display section to superimpose and display, in the image displayed on the display section, an image of a form obtained by simplifying the image based on the incidental information.

11. The image pickup apparatus according to claim 2, further comprising a resolution determining section configured to determine on the basis of a preset recording image size information and size information of the incidental information image set by the operation section whether a size of the incidental information image is appropriate, wherein
the display control section performs control for displaying a predetermined warning display on the display screen of the display section when a determination result by the resolution determining section is negative.

12. The image pickup apparatus according to claim 11, wherein, when the incidental information image size set by the operation section is smaller than a minimum value specified in advance, the resolution determining section determines that the incidental information image size set by the operation section is inappropriate and the determination result is negative.

13. The image pickup apparatus according to claim 11, wherein, when the determination result by the resolution determining section is negative, the display control section performs the warning display and, at a same time, performs display for urging resetting operation of the incidental information image size.

14. An image pickup system comprising:
an image pickup apparatus including:
an image pickup section configured to receive an optical image of an object and generate and output image data;
a display section configured to display an image based on the image data outputted from the image pickup section and various kinds of information;
a body-side communication section configured to perform communication between the body-side communication section and a terminal apparatus and acquire incidental information concerning the object; and
a display control section configured to perform processing of superimposing/displaying an image in the image displayed on the display section based on the incidental information corresponding to the image in a position designated in advance; and
a terminal apparatus including:
a terminal-side communication section configured to perform communication between the terminal-side communication section and the image pickup apparatus via the body-side communication section;
a recording section configured to record an information data group concerning a recording target event including a plurality of kinds of incidental information concerning a plurality of image pickup object; and
an image processing section configured to prepare an incidental information image based on incidental information concerning each of individual image pickup objects on the basis of information data group recorded in the recording section.

15. The image pickup system according to claim 14, wherein the terminal apparatus further includes a recording section configured to record image data acquired by the image pickup apparatus and image data representing the incidental information image corresponding to the image data in association with each other.

16. The image pickup system according to claim 14, further comprising a combined-image preparing section configured to generate combined image data obtained by combining image data acquired by the image pickup apparatus and image data representing the incidental information image corresponding to the image data.

17. The image pickup system according to claim 16, wherein the terminal apparatus further includes a collation-information preparing section configured to calculate, as collation information, a detection value for detecting falsification of a combined image from the combined image data.

18. The image pickup system according to claim 17, wherein the recording section of the terminal apparatus records the combined image data and the collation information in association with each other.

19. An image pickup method comprising:
preparing a plurality of incidental information images corresponding to each of individual image pickup objects on the basis of an information data group concerning a recording target event including a plurality of kinds of incidental information concerning a plurality of image pickup objects;
transferring the plurality of incidental information images between a terminal apparatus and an image pickup apparatus;
receiving an optical image of the image pickup object and generating image data;
displaying an image based on the image data and superimposing and displaying, in a position designated in advance in a display screen, a specific incidental information image corresponding to the displayed image among the plurality of incidental information images; and
recording image data representing the displayed image and data representing the incidental information image corresponding to the image data in association with each other.

20. An image pickup program comprising:
preparing a plurality of incidental information images corresponding to each of individual image pickup objects on the basis of an information data group concerning a recording target event including a plurality of kinds of incidental information concerning a plurality of image pickup objects;
receiving an optical image of the image pickup object and generating image data;
displaying an image based on the image data and superimposing and displaying, in a position designated in advance in a display screen, a specific incidental information image corresponding to the displayed image among the plurality of incidental information images; and
recording image data representing the displayed image and data representing the incidental information image corresponding to the image data in association with each other.

21. A display apparatus for image pickup comprising:
a display section configured to display an image based on image data outputted from an image pickup section, which is configured to receive an optical image of an object and generate and output image data, and various kinds of information;
a communication section configured to perform communication between the communication section and a terminal apparatus and acquire incidental information concerning the object; and
a display control section configured to perform processing of superimposing/displaying an image in the image displayed on the display section based on the incidental information corresponding to the image, wherein
the display control section performs display control for displaying the image based on the incidental information in a position designated in advance in a display screen of the display section.

22. The display apparatus for image pickup according to claim 21, further comprising an operation section configured to perform operation for changing a display position and a display size of the image in the display screen based on the incidental information, wherein
the display control section performs display control for changing the display position and the display size of the image in the display screen based on the incidental information according to the display change operation by the operation section.

23. The display apparatus for image pickup according to claim 22, wherein the communication section transfers, to the terminal apparatus, information concerning the display position and the display size of the image in the display screen based on the incidental information changed by the display control section according to the display change operation by the operation section.
